(19) United States
(12) Patent Application Publication
(10) Pub. No.: US 2024/0150858 A1
(43) Pub. Date: May 9, 2024

(54) USE OF MIXTURES COMPRISING GLYCEROL AND GLYCERIDES OF ORGANIC ACIDS IN AGRICULTURAL AND FORESTRY

(71) Applicants: Alessio Paoli, Firenze (IT); Fernando Cantini, Firenze (IT)

(72) Inventors: Alessio Paoli, Firenze (IT); Fernando Cantini, Firenze (IT)

(21) Appl. No.: 18/280,528

(22) PCT Filed: Mar. 8, 2022
(86) PCT No.: PCT/IB2022/052023

§ 371 Date: Sep. 6, 2023

(30) Foreign Application Priority Data
Mar. 8, 2021 (IT) 102021000005360

(51) Int. Cl. C14C 3/02; A01C 1/06; A01N 59/20; A01P 3/00

(52) U.S. Cl. CPC C14C 3/02; A01C 1/06; A01N 59/20; A01P 3/00

(57) ABSTRACT

The present invention describes the agricultural and/or forestry use of a mixture comprising: glycerol 5-90%, and glycerides of one or more organic acids 10-95% where the % are by weight with respect to the total mixture; wherein said mixture is used as a phytostimulating agent to promote the germination of seeds and/or as a fungicide/pesticide to protect seeds and/or crops against pathogenic microorganisms.

### FIELD OF THE INVENTION

The present invention relates to the field of the use of mixtures of glycerol and glycerides of organic acids in agriculture and forestry, in particular to increase the germination of seeds and/or to protect seeds and/or crops from pathogenic microorganisms.

BACKGROUND In the agricultural and forestry industry there has always been a need for non-toxic agents to facilitate germination and/or protect seeds and/or crops from pathogenic microorganisms.

According to the state of the art, the most widely used and effective fungicides are those based on copper (e.g. Kocide®, Curzate®, Cuproxat®).

Auxinic agents are among the products known to date to promote the germination of seeds.

WO/2010/106488 describes a composition comprising monoglycerides of organic acids C₁-C₇ 10-90% w/w and glycerol 10-90% w/w for use as antibacterials and use thereof as feed additives/liquids intended for feeding farm animals but also as anti-mould agents for cereal preservation.

The object of the present invention is to provide a novel method for facilitating the germination of seeds and/or protecting the seeds and/or the crops from pathogenic microorganisms.

### SUMMARY OF THE INVENTION

An object of the present invention is the agricultural and/or forestry use of a mixture comprising or consisting of:
glycerol 5-90%, and
glycerides of one or more organic acids 10-95%
where the % are by weight with respect to the total mixture; in particular as phytostimulating agents to promote the germination of seeds and/or as fungicides/pesticides to protect seeds and/or crops from pathogenic microorganisms.

Surprisingly, it was observed that:
treating seeds with aqueous solutions of said mixtures increases the germination index and also the length of the rootlets;
said mixtures are effective against pathogenic fungi in the tanning of infected seeds
said mixtures were effective in both in vitro and field tests in inhibiting the mycelial growth of pathogenic fungi of agricultural and forestry interest;
said mixtures have demonstrated to be effective in vitro on pathogenic bacteria of agricultural interest, which are the agents of severe bacterial diseases on horticultural and other species,
said mixtures have demonstrated to have no adverse effects on nitrogen-fixing bacteria producing Indolacetic Acid (IAA), a promoter of root growth;
said mixtures show a synergistic effect when used in combination with copper based fungicides.

An object of the present invention is a phytostimulating composition for promoting seed germination and increasing the length of the rootlets, said composition comprising a mixture as described above.

The subject matter of the application is also a method for increasing the germination of seeds and/or the length of the rootlets, said method comprising treating the seed by imbibition with the composition as such or with an aqueous solution of a mixture as described above.

An object of the present invention is also a fungicide/pesticide composition comprising a mixture as described above and optionally a copper based fungicide.

An object of the invention is also a fungicide/pesticide method in which a crop is treated with a composition as described above.

An object of the present invention is also a composition of tanning infected seeds or seeds susceptible to infection, said composition comprising a mixture as described above.

An object of the present invention is also a method of tanning an infected seed or a seed susceptible to infection, said method comprising contacting the seed with the tanning composition described above.

### DETAILED DESCRIPTION OF THE INVENTION

For the purposes of the present invention, the agricultural and forestry use is understood in its proper sense, i.e. use in the cultivation of plant species (from germination to harvest). For the purposes of the present invention, glycerides means mono-, di- and/or tri-glycerides and mixtures thereof of organic acids. The mixtures according to the present invention may not only be mixtures of mono-, di- and/or triglycerides of a single organic acid, but may also be mixtures comprising mixed di- and tri-glycerides of 2 or more organic acids.

Preferably the mixtures for use according to the present invention contain 10-90% monoglycerides, more preferably 40-90%.

Preferably the content of glycerol mixed with glycerides is 10-60%.

Preferably according to the present invention, the organic acids are selected from C1-C12 and C16-C20.

According to the present invention, the organic acids are preferably selected from formic acid, acetic acid, propionic acid, butyric acid, isobutyric acid, valeric acid, caproic acid, heptanoic acid, caprylic acid, nonanoic acid, capric acid, undecanoic acid, lauric acid, fatty acids from soybean oil (i.e. palm itic acid; stearic acid; oleic acid; linoleic acid; linolenic acid; arachidonic acid), oxalic acid, adipic acid, succinic acid, citric acid, tartaric acid, benzoic acid, cinnamic acid, salicylic acid, fumaric acid, gluconic acid, azelaic acid and mixtures thereof.

For the purposes of the present invention, the mixtures comprising glycerol and glycerides of propionic acid, butyric acid, isobutyric acid, valeric acid, caproic acid, heptanoic acid, caprylic acid, nonanoic acid, capric acid, undecanoic acid, lauric acid, soybean oil fatty acids and mixtures thereof are preferred; more preferably propionic acid, butyric acid, propionic acid+butyric acid, heptanoic acid, lauric acid and soybean fatty acids.

The use of the mixtures according to the present invention has proved particularly effective in increasing the germination index and/or the length of the rootlets of basil, tomato, salad, radish and courgette seeds.

The use of the mixtures according to the present invention has proved particularly effective in the tanning of wheat seed infected with Tilletia caries.

The use of the mixtures according to the present invention has proved particularly effective in counteracting the growth of pathogenic bacteria such as Pseudomonas syringae pv tomato (DC 3000), Clavibacter michiganensis subsp. michiganensis (CMM), Pseudomonas savastanoi,

The use of the mixtures according to the present invention has demonstrated to have no adverse effects on the growth of Azospirillum brasilense (nitrogen-fixing bacterium).

The use of the mixtures according to the present invention has been shown to be particularly effective in counteracting the mycelial growth of Botyris cinerea, Fusarium Graminearum, Fomitiporia Mediterranea, Phaeomoniella Chlamydospora, Phytophthora Cinnamoni, Phytophthora Ramorum, Colletotrichum Coccodes, Botryosphaeria Dothidea and Colletotrichum Lupini.

In field tests on vine crops, the use of the mixtures according to the present invention has been shown to be effective in counteracting Plasmopara viticola, and unexpectedly, the mixtures of the invention have been shown to have synergistic effects with copper based products (such as Curzate® or Cuproxat®) so that their doses can be halved to achieve the same efficacy.

The present invention can be better understood in the light of the following embodiments.

### BRIEF DESCRIPTION OF THE DRAWINGS

FIG. 1 shows the scheme of preparation of the products tested in this description.

FIG. 2: shows the process for setting up the Petri dishes used for the seed germination tests.

FIG. 3 shows A: number of germinated basil seeds treated with the products of this description compared to the control group treated with water; B: average measurement in cm of the rootlets of the germinated seeds.

FIG. 4 shows A: number of germinated tomato seeds treated with the products of this description compared to the control group treated with water; B: average measurement in cm of the rootlets of the germinated seeds.

FIG. 5 shows A: number of germinated salad seeds treated with the products of this description compared to the control group treated with water B: average measurement in cm of the rootlets of the germinated seeds.

FIG. 6: shows A: number of germinated radish seeds treated with the products of this description compared to the control group treated with water B: average measurement in cm of the rootlets of the germinated seeds.

FIG. 7: shows A: number of germinated courgette seeds treated with the products of this description compared to the control group treated with water B: average measurement in cm of the rootlets of the germinated seeds.

FIG. 8: shows microscopic images of Tilletia caries spores treated with (A) water, (B) PR2, (C) PR3 and (D) PR4.

FIG. 9: shows a Petri dish used for the test on Colletotrichum Lupini.

FIG. 10: shows the results of the test on vines in greenhouse, infected with artificial inoculum and treated with the products of the present invention.

### EXPERIMENTAL PART

### Example 1—General Procedure for the Production of the Tested Mixtures

Each esterification reaction was conducted in 10,000 kg batches in a reactor equipped with a vertical reflux condenser.

Starting glycerol and fatty/organic acids were loaded into the reactor at room temperature as shown in Table 1.

The mixture was heated up to 110° C. by dropping the starting materials into the reactor via the vertical reflux condenser.

Once the temperature of 110° C. had been reached, the reaction mixture was heated to 150° C., raising the temperature by 2° C. at a time, keeping the pressure under control so that it did not exceed 0.5 BAR. When the mixture reached 150° C., the temperature at the head of the vertical condenser was set to 110° C. to allow evaporation of the water from the esterification reaction and the reactor temperature was raised up to 235° C. (235° C. are reached by raising the temperature 1° C. at a time, keeping the Pressure always <0.5 BAR). Once the reaction mixture reached a temperature of 235° C., it was thermo-stabilised until the free acidity value (determined by ISO 660:2009 method) was equal to or less than 2%. When this value was reached, once the temperature of the vertical condenser had been set at a temperature equal to 140° C., the vacuum was attached which allowed the unreacted starting acid to be distilled and therefore to reach a free acidity value equal to or less than 0.1%.

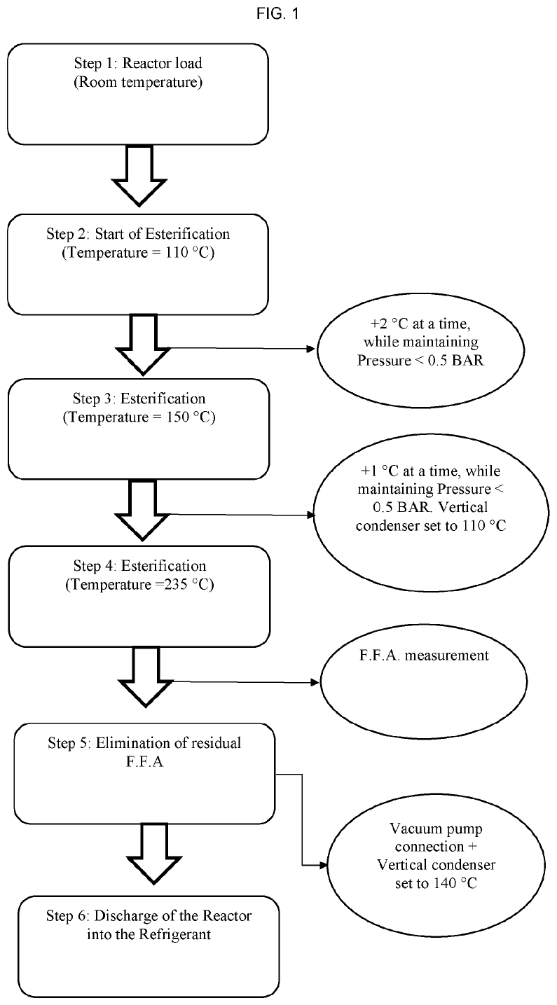

The product was then discharged into a refrigerant and cooled to room temperature. The aforesaid procedure is also illustrated in the block diagram in FIG. 1.

TABLE 1
Mixtures produced

| | Glycerol | | |
|---|---|---|---|
| Product# | (kg) | Acid(s) (kg) | Acid(s) |
| PR 1 | 6875 | Propionic acid: 2250 | Propionic acid |
| | | Butyric acid: 875 | Butyric acid |
| PR 2 | 3000 | 7000 | Propionic acid |
| PR 3 | 6000 | Valeric acid: 116 | Valeric acid |
| | | Caproic acid: 1004 | Caproic acid |
| | | Heptanoic acid: 360 | Heptanoic acid |
| | | Caprylic acid: 1332 | Caprylic acid |
| | | Nonanoic acid: 1188 | Nonanoic acid |
| PR 4 | 6000 | 4000 | Nonanoic acid |
| PR 5 | 3500 | 6500 | Butyric acid |
| PR 6 | 3000 | 7000 | Citric acid |
| PR 7 | 3000 | 7000 | Adipic acid |
| PR 8 | 3000 | 7000 | Benzoic acid |
| PR 9 | 7000 | 3000 | Lauric acid |
| PR 10 | 6000 | Caprylic acid: 2200 | Caprylic acid |
| | | Capric acid: 1800 | Capric acid |
| PR 11 | 3200 | 6800 | Valeric acid |
| PR 12 | 3000 | 7000 | Acetic acid |
| PR 13 | 3000 | 7000 | Salicylic acid |
| PR 14 | 2500 | 7500 | Fumaric acid |
| PR 15 | 3000 | 7000 | Gluconic acid |
| PR 16 | 6500 | 3500 | Undecanoic acid |
| PR 17 | 3000 | 7000 | Isobutyric acid |
| PR 18 | 3500 | 6500 | Succinic acid |
| PR 19 | 7300 | 2700 | Fatty acids from |
| | | | soybean oil¹ |
| PR 20 | 6000 | 4000 | Caprylic acid |
| PR 21 | 3500 | 6500 | Oxalic acid |
| PR 22 | 3000 | 7000 | Formic acid |
| PR 23 | 4000 | 6000 | Butyric acid |
| PR 24 | 7300 | 2700 | Butyric acid |
| PR 25 | 6500 | 3500 | Butyric acid |
| PR 26 | 8100 | 1900 | Butyric acid |
| PR 27 | 3000 | 7000 | Heptanoic acid |
| PR 28 | 4000 | 6000 | Heptanoic acid |
| PR 29 | 5000 | 5000 | Heptanoic acid |
| PR 30 | 6000 | 4000 | Heptanoic acid |
| PR 31 | 3500 | 6500 | Azelaic acid |
| PR 32 | 6000 | 4000 | Azelaic acid |
| PR 33 | 6500 | 3500 | Butyric acid |
| PR 34 | 3000 | 7000 | Propionic acid |
| PR 35 | 3000 | 7000 | Tartaric acid |
| PR 36 | 3000 | 7000 | Cinnamic acid |
| PR 37 | 4000 | 6000 | Cinnamic acid |
| PR 38 | 5500 | 4500 | Cinnamic acid |
| PR 39 | 6000 | 4000 | Cinnamic acid |
| PR 40 | 7000 | 3000 | Propionic acid |

¹palmitic acid 8-13.5%; stearic acid 2-5.4%; oleic acid 17-30%; linoleic acid 48-59%; α-linolenic acid 4.5-11; arachic acid 0.1-0.6%, where the % are by weight with respect to the total weight of the fatty acids from soybean oil.

### EXAMPLE 2—Characterisation of the Products Obtained From Example 1

All products obtained according to Example 1 are characterised and analysed using the following analytical methods shown in Table 2:

TABLE 2
Analytical methods used for the chemical characterisation of the products

| Analytical parameter | Method of analysis |
|---|---|
| Free Glycerol | Example 2.1 |
| Glycerides of fatty/organic acids | Example 2.2 |
| Moisture | ISO 8534:2017 |
| Free acidity (F.F.A.)/Acid number | ISO 660:2009 |
| Ashes | ISO 6884:2008 |
| Saponification number | ISO 3657:2013 |

### EXAMPLE 2.1—Determination of Free Glycerol

### 2.1.1. Subject-Matter

This method specifies a titration process for the determination of content of glycerol in products containing mono- and triglycerides of fatty/organic acids and glycerol. The method is applicable to both liquid and powdered products.

### 2.1.2. Principle of the Method

The cold oxidation of glycerol by sodium metaperiodate in an acid medium produces formic acid according to the following reaction:

HOCH₂—CH(OH)—CH₂OH+2IO₄→2 HCHO+HCOOH+2 IO₃₋+H₂O

After removing the excess periodate with 1,2-ethanediol, the formic acid produced by the reaction is titrated with a standard volumetric solution of potassium hydroxide, using the bromothymol blue indicator.

### 2.1.3. Procedure

Weigh 0.30-0.40 g of the sample to be analysed into a 600 ml beaker.

Add 50 ml of distilled water to the sample using a 50 ml graduated cylinder. After adding the water, add 0.15-0.20 g bromothymol blue indicator (0.4% alcohol solution) using a Pasteur pipette and acidify with 0.01 N hydrochloric acid solution until the solution turns yellow-green (this acidification step should only be done if the solution is not already yellow).

Add 0.1 N potassium hydroxide drop by drop until the colour of the solution turns blue without any green tinge.

Add 50 ml of sodium metaperiodate solution (60 g/l), stir gently and cover the beaker with a watch glass. Allow to stand/react (30 minutes) in the dark.

After the reaction time, add 10 ml of ethylene glycol solution, stir gently and cover the beaker with a watch glass during the reaction period (20 minutes) in the dark.

After the reaction time has elapsed, make up to volume up to 300 ml with distilled water, add 0.15-0.20 g bromothymol blue indicator using a pasteur pipette and stir gently. Titrate the solution with 0.1 N potassium hydroxide solution until the solution turns blue without green tinge.

At the same time as the above determination and under the same conditions, carry out a blank test without the sample, using the same quantities of reagents.

### 2.1.4. Expression of the Result

The titre of glycerol is given, as a weight percentage, by the formula:

$$Glycerol content = \frac{{( {V}_{1} - {V}_{0} )}^{*} {N}^{*} 9.209}{m}$$

where:
V₁=volume (ml) of the potassium hydroxide solution used for the titration of the sample
V⁰=volume (ml) of the potassium hydroxide solution used for the blank test
N=normality factor of the standard volumetric potassium hydroxide solution
m=mass (g) of the sample taken for determination

### EXAMPLE 2.2—Determination of the Content of Glycerides of Fatty/Organic Acids

This calculation method is used to determine the total glyceride content in mixtures containing only free glycerol, water, glycerides and free fatty/organic acids.

This method can only be applied after other parameters have been determined using the following methods:
Water content: ISO 8534:2017
Free glycerol: Method example 2.1
Free acidity: ISO 660:2009

The glyceride content (GC) is calculated as shown below:

GC=100−(WC+FG+FFA)

wherein:
GC=glyceride content of fatty/organic acids
WC=water content
FG=Free Glycerol
FFA=Free acidity

### EXAMPLE 2.3—Calculation of Acid Content (% on 100 q of product)

$$\% of acid on 100 g product = \frac{( Saponification No . ) \times PM}{56.1} \times 10$$

Where:
PM=Molecular weight of the fatty/organic acid
56.1=Molecular weight Potassium hydroxide (KOH 0.1 N)

Table 3 shows the chemical-physical characterisation of the products obtained from the starting materials listed in Table 1.

TABLE 3
Chemical and physical characterisation of the products

| | | | | Acid | | | | Physical | | | |
|---|---|---|---|---|---|---|---|---|---|---|---|
| | Free | | | number | | Saponification | Amount of | appearance | Physical | Physical | Melting |
| Product | glycerol | Glycerides | Moisture | (mg | | number (mg | acid in the | at room | appearance | appearance | point |
| code | (%) | (%) | (%) | KOH/g) | Ashes | KOH/g) | product (%) | temperature | at +4° C. | at −18° C. | (° C.) |
| PR 1 | 39.4 | 48.9 | 9.32 | 13.34 | 1.4 | 178.3 | na | Liquid | Liquid | Liquid | — |
| PR 2 | 37.3 | 44.2 | 14.80 | 6.82 | 2.90 | 188.3 | 24.8 | Liquid | Liquid | Liquid | — |
| PR 3 | 17.3 | 82.3 | 0.07 | 1.10 | 0.00 | 253.6 | na | Liquid | Solid | Liquid | — |
| PR 4 | 14.6 | 83.5 | 0.84 | 3.91 | 0.00 | 196.3 | 55.3 | Solid | Solid | Solid | 35 |
| PR 5 | 41.3 | 58.5 | 0.10 | 0.64 | 0.00 | 241 | 37.8 | Liquid | Liquid | Liquid | — |
| PR 6 | 43.9 | 54.3 | 0.18 | 3.51 | 0.00 | 222 | 76.0 | Liquid | Liquid | Solid | — |
| PR 7 | 39.0 | 60.7 | 0.07 | 1.92 | 0.00 | 255.1 | 66.4 | Liquid | Liquid | Solid | — |
| PR 8 | 51.1 | 48.1 | 0.31 | 2.30 | 0.00 | 148.5 | 32.3 | Liquid | Liquid | Solid | — |
| PR 9 | 9.2 | 90.5 | 0.11 | 0.56 | 0.00 | 219.7 | 78.3 | Solid | Solid | Solid | 50 |
| PR 10 | 15.1 | 84.7 | 0.12 | 0.51 | 0.00 | 231 | na | Solid | Solid | Solid | 23 |
| PR 11 | 39.2 | 55.8 | 4.1 | 4.95 | 0.00 | 208.6 | 37.9 | Liquid | Liquid | Liquid | — |
| PR 12 | 40 | 58.7 | 1.08 | 1.87 | 0.00 | 280 | 29.9 | Liquid | Liquid | Liquid | — |
| PR 13 | 62.7 | 33.9 | 0.79 | 10.6 | 0.00 | 57.2 | 14.1 | Liquid | Liquid | Liquid | — |
| PR 14 | 28.7 | 69.7 | 1.17 | 2.18 | 0.00 | 284.2 | 58.8 | Liquid | Solid | Solid | — |
| PR 15 | na | na | 2.67 | na | 0.00 | 81.9 | 28.6 | Liquid | Liquid | Solid | — |
| PR 16 | 12.1 | 85.3 | 0.72 | 5.67 | 0.00 | 220.8 | 73.2 | Solid | Solid | Solid | 35 |
| PR 17 | 49.9 | 49.7 | 0.2 | 1.28 | 0.00 | 220.1 | 34.5 | Liquid | Liquid | Liquid | — |
| PR 18 | 26.8 | 70.0 | 2 | 5.56 | 0.00 | 338 | 71.1 | Liquid | Solid | Solid | — |
| PR 19 | 17.7 | 80.6 | 1.18 | 2.8 | 0.00 | 158.4 | na | Solid | Solid | Solid | 37 |
| PR 20 | 14.3 | 84.2 | 0.78 | 3.00 | 0.00 | 252.5 | 64.8 | Liquid | Solid | Solid | — |
| PR 21 | 72.9 | 14.2 | 8.3 | 28.7 | 0.00 | 178.7 | 28.7 | Liquid | Liquid | Liquid | — |
| PR 22 | 78.1 | 19.0 | 1.38 | 18.8 | 0.00 | 281.4 | 23.1 | Liquid | Liquid | Liquid | — |
| PR 23 | 32 | 67.6 | 0.17 | 1.28 | 0.00 | 275 | 43.1 | Liquid | Liquid | Liquid | — |
| PR 24 | 0.7 | 99.1 | 0.12 | 0.64 | 0.00 | 507.2 | 79.6 | Liquid | Liquid | Liquid | — |
| PR 25 | 2.7 | 96.7 | 0.45 | 1.28 | 0.00 | 452.4 | 71.0 | Liquid | Liquid | Liquid | — |
| PR 26 | 0 | 99.7 | 0.04 | 1.91 | 0.00 | 543.4 | 85.2 | Liquid | Liquid | Liquid | — |
| PR 27 | 53.5 | 44.7 | 0.68 | 4.96 | 0.00 | 134.1 | 31.1 | Liquid | Liquid | Liquid | — |
| PR 28 | 39.4 | 56.9 | 1.97 | 7.12 | 0.00 | 179 | 41.5 | Liquid | Liquid | Liquid | — |
| PR 29 | 26.1 | 73.7 | 0.06 | 0.73 | 0.00 | 228.1 | 52.9 | Liquid | Liquid | Liquid | — |
| PR 30 | 12.5 | 84.1 | 1.62 | 7.64 | 0.00 | 277.5 | 64.3 | Liquid | Liquid | Liquid | — |
| PR 31 | 39.6 | 56.9 | 1.27 | 6.56 | 0.00 | 220 | 73.7 | Liquid | Solid | Solid | — |
| PR 32 | 5.2 | 88.9 | 1.11 | 16.7 | 0.00 | 403.7 | na | Liquid | Solid | Solid | — |
| PR 33 | 0.97 | 95.6 | 1.02 | 15.3 | 0.00 | 457.2 | 71.7 | Liquid | Liquid | Liquid | — |
| PR 34 | 46.7 | 51.5 | 1.40 | 3.03 | 0.00 | 227 | 29.9 | Liquid | Liquid | Liquid | — |
| PR 35 | 58.4 | 39.5 | 1.79 | 1.05 | 0.00 | 231 | 61.8 | Liquid | Solid | Solid | — |
| PR 36 | 57.2 | 38.9 | 1.19 | 10.2 | 0.00 | 111.7 | 29.5 | Solid | Solid | Solid | >95 |
| PR 37 | 39.1 | 59.3 | 1.22 | 1.52 | 0.00 | 165.1 | 43.6 | Solid | Solid | Solid | >95 |
| PR 38 | 20.8 | 78.9 | 0.3 | 0.00 | 0.00 | 224.7 | 59.3 | Solid | Solid | Solid | >95 |
| PR 39 | 15.8 | 83.9 | 0.3 | 0.00 | 0.00 | 249.1 | 65.7 | Solid | Solid | Solid | >95 |
| PR 40 | 0.13 | 99.3 | 0.48 | 0.91 | 0.00 | 639 | 84.3 | Liquid | Liquid | Liquid | |

### EXAMPLE 2.4—Quantification of mono-, di- and tri-Glycerides of Butyric Acid

### 2.4.1. Subject-Matter

This method describes the procedure for the quantitative determination of glycerol monobutyrate, glycerol dibutyrate, glycerol tributyrate on both liquid and solid samples.

### 2.4.2. Principle of the Method

The liquid sample containing the mixture of constituents in different ratios is mixed with a specific internal standard. The acetylation reagent is added and the acetylation reaction is carried out on the free —OH functional groups of the glycerol. After dilution, the sample is injected into a Gas Chromatograph set up with an on column injector, non-polar capillary column and FID detector.

### 2.4.3 Operating Conditions Gas Chromatograph

Carrier gas flow (Helium): 1.5 ml/min
Column temperature ramp: 50° C. (1 min)→120° C. (20° C./min)→230° C. (7° C./min)+(5 minutes in isotherm)
FID detector: 300° C.
Type of injector: on-column

### 2.4.4. Procedure

Weigh approximately 20 mg of 1,2,4-butanetriol into a 10 ml screw-capped test tube (weighing accuracy±0.0001 g) and approximately 100 mg of sample (weighing accuracy±0.0001 g). Using a pipette, add 5 ml of the acetylating reagent (into a 100 ml volumetric flask pour 50 ml of ethyl acetate, 23 ml (or 24.8 g) of acetic anhydride, 1 ml of distilled water and 2 ml of 1-Methylimidazole. Make up to volume with ethyl acetate). Carefully close the test tube and heat it for 15 minutes in a water bath set to 80° C. Cool the test tube, open the screw cap and take approx. 100 μl of the reaction mixture with a microsyringe. Transfer it to a new test tube, dilute it with 5 ml of isooctane or n-heptane and inject into the Gas Chromatograph.

### 2.4.5. Expression of the Results

Several constants must be taken into account when calculating the results.

Table 4 shows the molecular weights of interest.

TABLE 4
Molecular weights of components

| Substance | Molecular weight |
|---|---|
| Glycerol | 92 |
| Glycerol triacetate | 218 |
| Butanetriol | 106 |
| Butanetriol triacetate | 232 |
| Glycerol Monobutyrate | 162 |
| Glycerol Monobutyrate diacetate | 246 |
| Glycerol Dibutyrate | 232 |
| Glycerol Dibutyrate monoacetate | 274 |
| Glycerol Tributyrate | 302 |

The responses to the FID of the different esters have a strong impact on analytical results. Table 5 shows the experimentally calculated response factors for all constituents.

TABLE 5
Response factors

| Substance | Response factor (RRF) |
|---|---|
| Glycerol triacetate | 1.08 |
| Butanetriol triacetate | 1.00 |
| Glycerol monobutyrate diacetate | 0.94 |
| Glycerol dibutyrate monoacetate | 0.80 |
| Glycerol tributyrate | 0.67 |

The weight percentages of the single components are calculated as follows:
Butanetriol triacetate (mg): weight of 1,2,4-butanetriol *(232/106)
Glycerol monobutyrate (% m/m)=(Glycerol monobutyrate area/Butanetriol triacetate area) *RRF *(162/246) *weight of Butanetriol triacetate *(100/sample weight)
Glycerol dibutyrate (% m/m)=(Glycerol dibutyrate area/Butanetriol triacetate area) *RRF *(232/274) *weight of Butanetriol triacetate *(100/sample weight)
Tributyrate glycerol (% m/m)=(Glycerol tributyrate area/Butanetriol triacetate area) *RRF *weight of Butanetriol triacetate *(100/sample weight)

### EXAMPLE 2.5—Quantification of mono-, di- and tri-Glycerides of Lauric Acid

### 2.5.1 Subiect-Matter

This method describes the procedure for the quantitative determination of glycerol monolaurate, glycerol dilaurate, glycerol trilaurate on both liquid and solid samples.

### 2.5.2 Principle of the Method

The sample containing the mixture of constituents in different ratios is derivatized as trimethyl silyl ether (TMSE). Silanising agents are added to the sample and the reaction on free -OH groups of glycerol is carried out at room temperature, using pyridine as a catalyst. After dilution, the sample is injected into a Gas Chromatograph equipped with an on-column injector, non-polar capillary column and FID detector.

All quantitative measurements are carried out by comparing the results obtained by Gas Chromatography with the sample saponification number, expressed in mg KOH/g and determined according to the ISO 3657:2013 method.

### 2.5.3. Operating Conditions Gas Chromatograph

Carrier gas flow (Helium): 1.5 ml/min
Column temperature ramp: 50° C. (1 min)→120° C. (20° C./min)→230° C. (7° C./min) →360° C. (10° C./min)+(5 minutes in isotherm)
FID detector: 300° C.
Type of injector: on-column

### 2.5.4. Procedure

Weigh approximately 5-10 mg of representative sample into a 10 ml screw-capped test tube (weighing accuracy±0.0001 g). Dissolve the sample in 50 μl of pyridine and add 50 μl of silanisation reagent (99 parts of Bis-trimethylsilyl-trifluoroacetamide +1 part of trimethylchlorosilane). Carefully close the test tube and allow to stand at room temperature for 20 minutes.

After the reaction time has elapsed, dilute the sample with 6 ml of n-heptane or isooctane, Inject 1 μl into the Gas Chromatograph using the one microsyringe.

### 2.5.5. Expression of the Results

Several constants must be taken into account when calculating the results. Table 6 shows the molecular weights of interest.

TABLE 6
Molecular weights of Components

| Substance | Molecular weight |
|---|---|
| Glycerol monolaurate | 274 |
| Glycerol dilaurate | 456 |
| Glycerol trilaurate | 638 |

The responses to the FID of the different esters have a strong impact on analytical results. Table 7 shows the experimentally calculated response factors for all constituents.

TABLE 7
Response factors

| Substance | Response factor (RRF) |
|---|---|
| Glycerol monolaurate | 1.00 |
| Glycerol dilaurate | 0.82 |
| Glycerol trilaurate | 0.73 |

The corrected peak areas of each component are calculated as follows:
Glycerol monolaurate (MO): Glycerol monolaurate area/RRF
Glycerol dilaurate (DI): Glycerol dilaurate area/RRF
Glycerol trilaurate (TRI): Glycerol trilaurate area/RRF

The weight percentages of the single components are calculated as follows:
Glycerol monolaurate (% m/m): 100*MO/(MO+DI+TRI)
Glycerol dilaurate (% m/m): 100*DI/(MO+DI+TRI)
Glycerol trilaurate (% m/m): 100*TRI/(MO+DI+TRI)

Table 8 shows the amounts of Monoglycerides, Diglycerides and Triglycerides of some products.

TABLE 8
Quantitative characterisation Products

| | MONO- | DIGLY- | TRIGLY- |
|---|---|---|---|
| | GLYCERIDES | CERIDES | CERIDES |
| PRODUCT | (%) | (%) | (%) |
| PR 5 | 47.00 | 13.00 | 1.00 |
| PR 9 | 42.00 | 39.00 | 8.00 |
| PR 23 | 50 | 18 | 1 |
| PR 24 | 9 | 44 | 44 |
| PR 25 | 26 | 50 | 19 |
| PR 26 | 0 | 0 | 99 |
| PR 33 | 21 | 50 | 23 |

### EXAMPLE 3—Germination Tests

To calculate the germination index (GI) of a series of seed varieties (see Table 9) following treatment with one of the products PR1-PR40 described above, the following test was set up:

Each product to be tested was diluted to 2-3 different concentrations (using sterile deionised water and emulsifier E433).

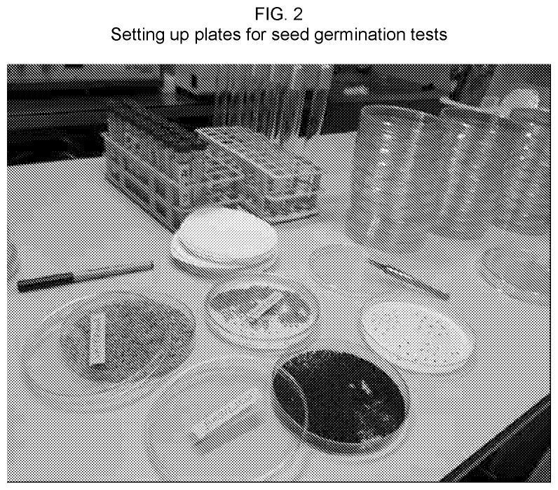

The experiment was carried out on a Petri dish: each plate containing No. 15 seeds lying between two discs of blotting paper carefully soaked in the product to be tested (FIG. 2) at the concentrations indicated above (e.g. for product No.1 a Petri dish was set up with 15 seeds inserted between two discs of blotting paper soaked in water, a plate with 15 seeds inserted between two discs of blotting paper soaked in 0.1% product, a plate with 15 seeds inserted between two discs of blotting paper soaked in 0.5% product and a plate with 15 seeds inserted between two discs of blotting paper soaked in 10% product). The plates containing the seeds were incubated for the times and at the temperatures indicated in Table 9. Following the incubation, the number of seeds germinated on the total of each plate and the length 20 in cm of any rootlets were noted

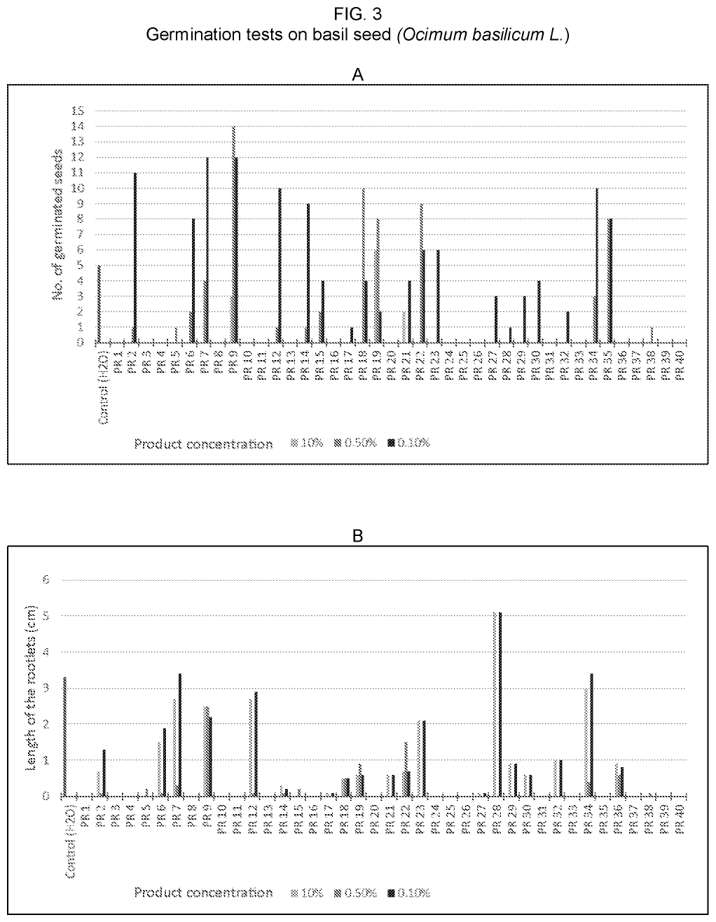

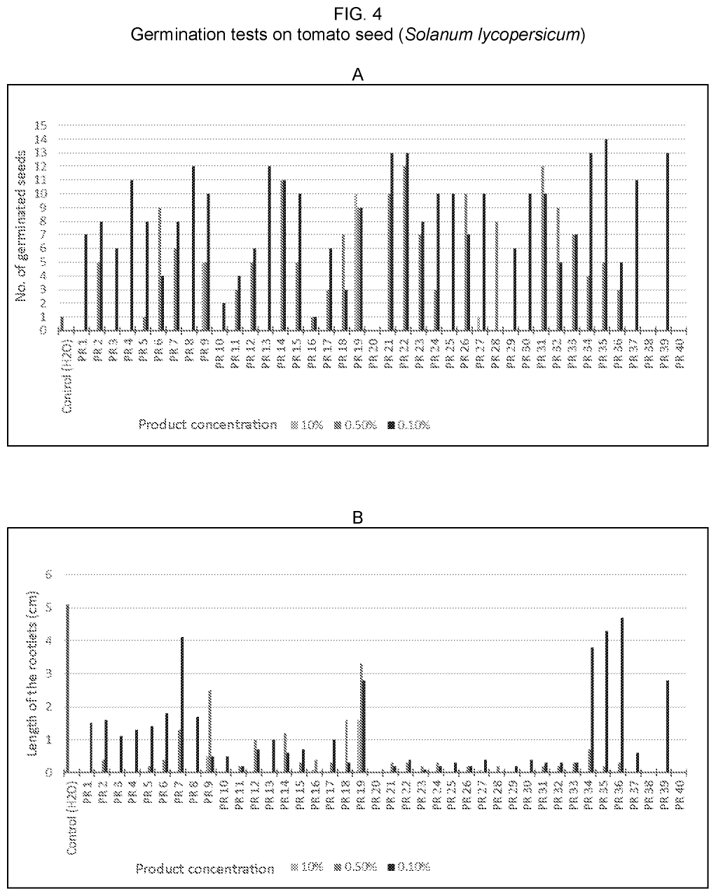

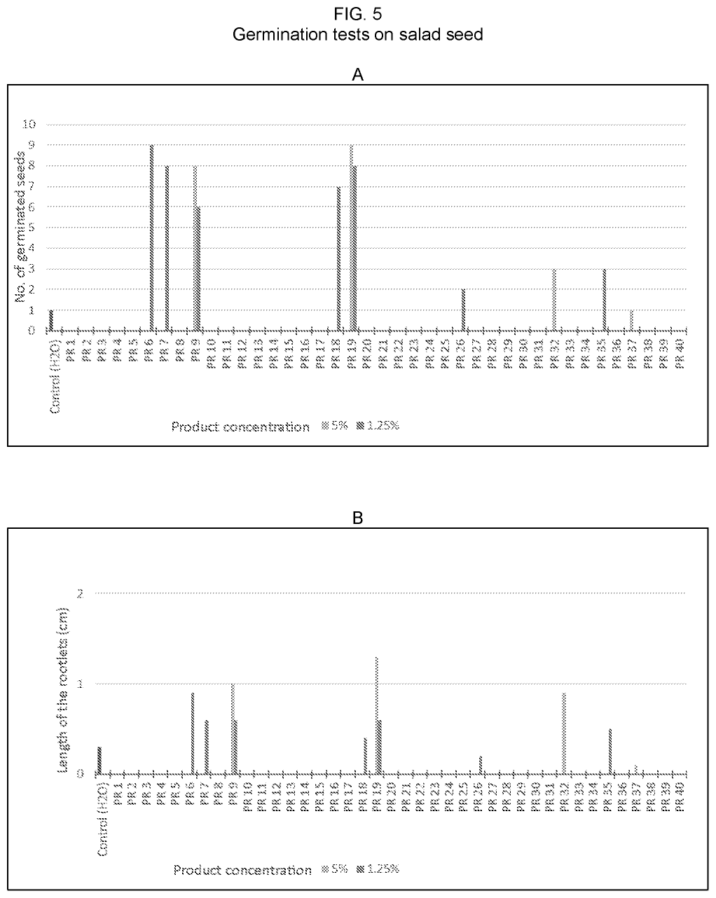

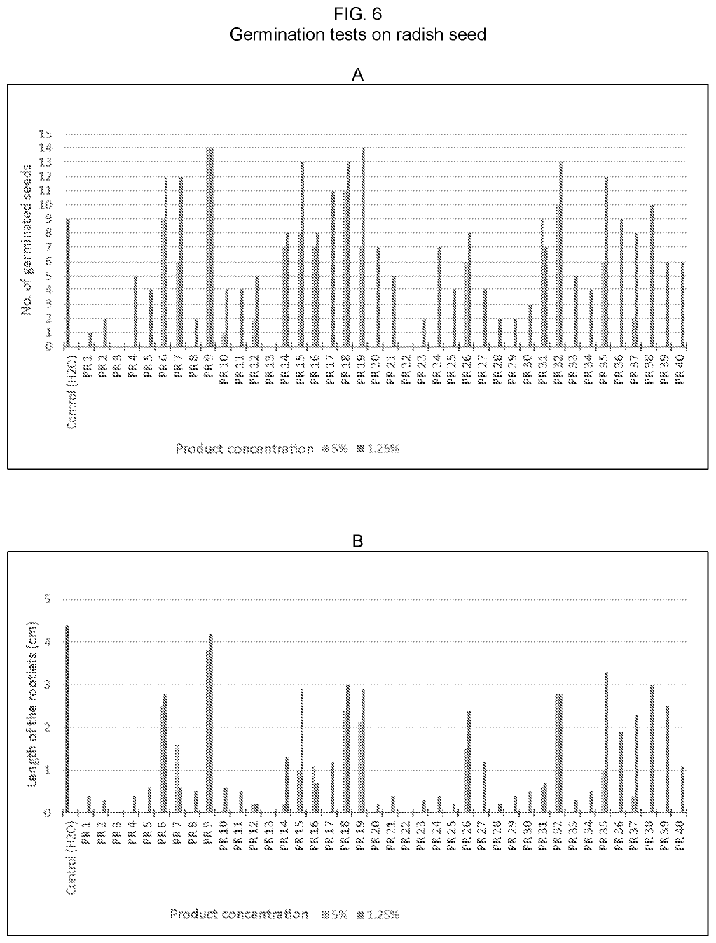

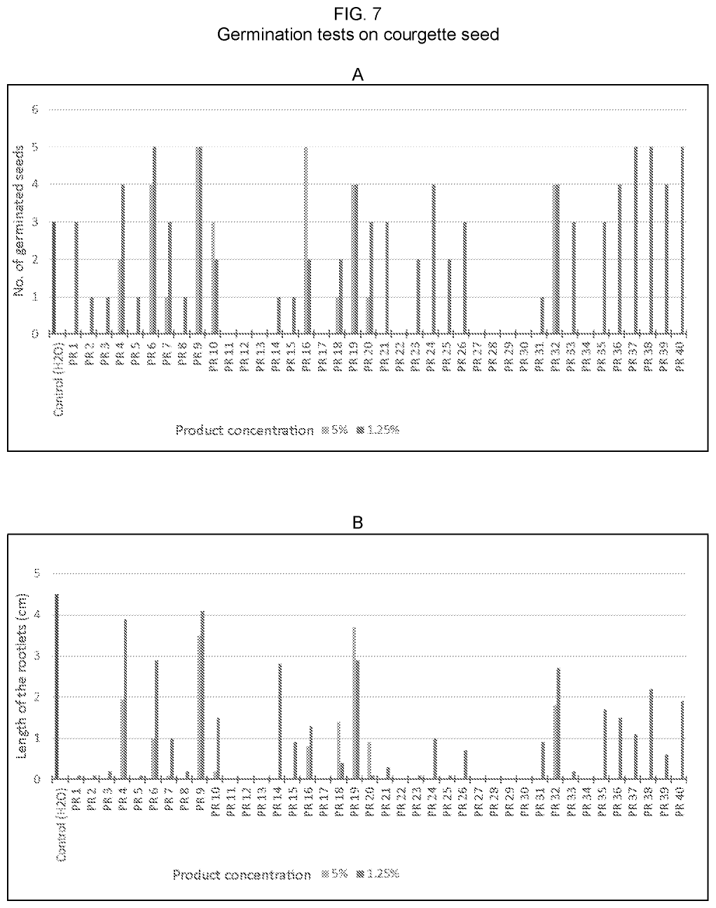

TABLE 9
Experimental conditions Germination test

| | Tested product | | |
|---|---|---|---|
| | concentrations | Incubation | |
| Seed | (% w/w) | conditions | Results |
| Seeds of Ocimum basilicum L., | 0.1; 0.5, 10 | 7 days at 37° C. | FIG. 3 |
| Neapolitan lettuce leaf variety, EC | | | |
| Regulation Pur. 97%, Germ 65% | | | |
| Seeds of Solanum lycopersicum L., | 0.1; 0.5, 10 | 12 days at 30° C. | FIG. 4 |
| Romaine variety | | | |
| Hooded variety lettuce seeds | 1.25; 5 | 8 days at 30° C. | FIG. 5 |
| Radish seeds | 1.25; 5 | 4 days at 30° C. | FIG. 6 |
| Courgette seeds | 1.25; 5 | 4 days at 30° C. | FIG. 7 |

### Results and Discussion Basil (FIG. 3)

Several products of the present invention have been shown to have an effect in increasing the number of germinated seeds compared to the control. This increase was evident and significant for products Nos. 2, 6 and 9 (increase ranging from 120% to 140% compared to the control group), which demonstrated to be the most active of the products even at the lowest concentration (0.1%).

Product No. 9 also shows to have excellent activity at the highest concentration (0.5%).

None of the above products have demonstrated to be effective in increasing the length of the rootlets of the germinated seeds.

The only product which demonstrated to be more effective than the control was product No. 28. In fact, a significant increase in the length of the rootlets is also observed when using product No. 28 at the lowest concentration (0.1%).

### Results and Discussion Tomato (FIG. 4)

On the germination of tomato seed, almost all the products tested have demonstrated to be active.

Among them, the products Nos. 21, 22, 34, 35 and 39 have demonstrated to have a significant effect even at the lowest concentration (0.1%), significantly increasing the number of germinated seeds compared to the control group treated only with water.

With regard to the length of the rootlets, however, none of the products tested have demonstrated to be more effective than water.

Of the products tested, those with the greatest efficacy were products Nos. 35 and 36.

### Results and Discussion Salad (FIG. 5)

The products Nos. 6, 7 and 19 show efficacy even at the lowest concentration (1.25%). At the same time, the products 9 and 19 showed efficacy even at higher concentrations equal to 5%.

The rest of the products tested are less effective on the germination of tomato seeds than the aforementioned products, but still more effective than water. With regard to the length of the rootlets, the products Nos. 6, 7, 9 and 19 have, as well as with regard to the germination of the seeds, demonstrated to have good growth efficiency.

### Results and Discussion Radish (FIG. 6)

The products 9 and 19 even at the lowest concentration tested (1.25%) have demonstrated to have a significant efficacy on the germination of radish seeds. The length of the rootlets, on the other hand, seems to be influenced only by product 9, while the other products tested, while increasing the number of germinated seeds, did not prove to be effective in lengthening the rootlets.

### Results and Discussion Courgette (FIG. 7)

The products Nos. 6, 9, 37, 38 and 40 positively influence the germination of courgette seeds, while at the same time none of the tested products allows a growth of the rootlets above water.

It can therefore be concluded that the two products that have the best activity both on the germination of seeds and on the increase in the length of the rootlets are products Nos. 9 and 19.

In any case, it is clear that much depends both on the seed being treated with the products covered by the present invention, and on the phase being examined. In facts, the results demonstrate that some products can be used to increase seed germination while others are excellent root growth promoters.

### EXAMPLE 4—Tanning of Wheat Seed Infected With Tilletia Caries

The analysis of the efficacy of the treatment with products Nos. 2, 3 and 4 on seed was performed on wheat naturally infected with Tilletia caries. Tanning treatments were performed by immersion (100 ml per 30 g of seed), using an aqueous solution of the products at 0.1% concentration.

Only the residence in the solution for 24 hours totally inhibited the germination of Tilletia caries, resulting in the complete emptying of the cellular content of the spores, whereas residence for 1 and 3 hours had no effect on spore germination. No adverse effect on the germination of seeds was then recorded.

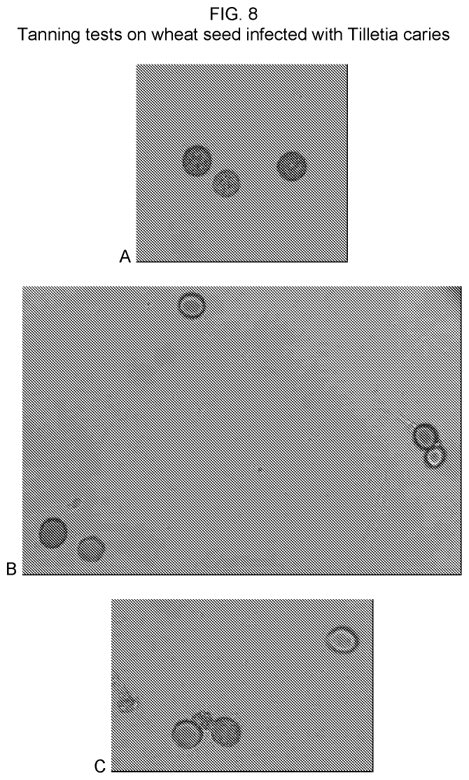

FIG. 8 shows microscopic images of Tilletia caries spores treated with (A) water (control), (B) PR2, (C) PR3 and (D) PR4.

### EXAMPLE 5—Tests on Fungi

The in vitro efficacy of certain products of the present invention in inhibiting mycelial growth of pathogenic fungi of agricultural and forestry interest has been tested. The growth substrate used was malto-agar, 3 replicates for the control not supplemented with the products and 3 replicates for each of the products at different concentrations.

Diameter growth was measured daily for each replicate. The products supplemented to the growth substrate were tested at concentrations of 1, 2 and 10%.

In the following tables, the value expressed in centimetres (cm) refers to the average growth of the 3 replicates.

TABLE 10
Botrytis cinerea

| | | Growth | Growth | Growth | Growth | Growth |
|---|---|---|---|---|---|---|
| | | (cm) | (cm) | (cm) | (cm) | (cm) |
| | Tanning | after 1 | after 2 | after 3 | after 4 | after 5 |
| Product | (% w/w) | day | days | days | days | days |
| Control | | 0.9 | 3.5 | 5.4 | 6.9 | 8.5 |
| PR1 | 1% | 0 | 0 | 0 | 0 | 0 |
| | 2% | 0 | 0 | 0 | 0 | 0 |
| | 10% | 0 | 0 | 0 | 0 | 0 |
| PR2 | 1% | 0 | 0 | 0.3 | 0.3 | 0.3 |
| | 2% | 0 | 0 | 0 | 0 | 0 |
| | 10% | 0 | 0 | 0 | 0 | 0 |
| PR3 | 1% | 0 | 0 | 0 | 0 | 0 |
| | 2% | 0 | 0 | 0 | 0 | 0 |
| | 10% | 0 | 0 | 0 | 0 | 0 |
| PR4 | 1% | 0 | 0 | 0 | 0 | 0 |
| | 2% | 0 | 0 | 0 | 0 | 0 |
| | 10% | 0 | 0 | 0 | 0 | 0 |
| PR5 | 1% | 0 | 0.6 | 1.1 | 1.5 | 1.5 |
| | 2% | 0 | 0.4 | 1 | 1.3 | 1.3 |
| | 10% | 0 | 0 | 0 | 0 | 0 |

TABLE 11
Fusarium Graminearum

| | | Growth | Growth | Growth | Growth | Growth | Growth | Growth |
|---|---|---|---|---|---|---|---|---|
| | | (cm) | (cm) | (cm) | (cm) | (cm) | (cm) | (cm) |
| | Tanning | after 1 | after 2 | after 3 | after 4 | after 5 | after 6 | after 7 |
| Product | (% w/w) | day | days | days | days | days | days | days |
| Control | | 0 | 0.4 | 2.2 | 3.9 | 6.2 | 7.1 | 8.5 |
| PR1 | 1% | 0 | 0 | 0 | 0 | 0 | 0 | 0 |
| | 2% | 0 | 0 | 0 | 0 | 0 | 0 | 0 |
| | 10% | 0 | 0 | 0 | 0 | 0 | 0 | 0 |
| PR2 | 1% | 0 | 0 | 0 | 0.5 | 1.3 | 1.9 | 3.1 |
| | 2% | 0 | 0 | 0 | 0 | 0 | 0 | 0 |
| | 10% | 0 | 0 | 0 | 0 | 0 | 0 | 0 |
| PR3 | 1% | 0 | 0 | 0 | 0 | 0 | 0 | 0 |
| | 2% | 0 | 0 | 0 | 0 | 0 | 0 | 0 |
| | 10% | 0 | 0 | 0 | 0 | 0 | 0 | 0 |
| PR4 | 1% | 0 | 0 | 0 | 0 | 0 | 0 | 0 |
| | 2% | 0 | 0 | 0 | 0 | 0 | 0 | 0 |
| | 10% | 0 | 0 | 0 | 0 | 0 | 0 | 0 |
| PR5 | 1% | 0 | 0 | 0 | 0.7 | 1.4 | 2.2 | 3.2 |
| | 2% | 0 | 0 | 0 | 0 | 0 | 0 | 0 |
| | 10% | 0 | 0 | 0 | 0 | 0 | 0 | 0 |

TABLE 12a
Fomitiporia Mediterranea

| | | Growth | Growth | Growth | Growth | Growth |
|---|---|---|---|---|---|---|
| | | (cm) | (cm) | (cm) | (cm) | (cm) |
| | Tanning | after 1 | after 2 | after 3 | after 4 | after 5 |
| Product | (% w/w) | day | days | days | days | days |
| Control | | 0 | 0 | 0.5 | 0.9 | 1.3 |
| PR1 | 1% | 0 | 0 | 0 | 0 | 0 |
| | 2% | 0 | 0 | 0 | 0 | 0 |
| | 10% | 0 | 0 | 0 | 0 | 0 |
| PR2 | 1% | 0 | 0 | 0 | 0 | 0 |
| | 2% | 0 | 0 | 0 | 0 | 0 |
| | 10% | 0 | 0 | 0 | 0 | 0 |
| PR3 | 1% | 0 | 0 | 0 | 0 | 0 |
| | 2% | 0 | 0 | 0 | 0 | 0 |
| | 10% | 0 | 0 | 0 | 0 | 0 |
| PR4 | 1% | 0 | 0 | 0 | 0 | 0 |
| | 2% | 0 | 0 | 0 | 0 | 0 |
| | 10% | 0 | 0 | 0 | 0 | 0 |
| PR5 | 1% | 0 | 0 | 0 | 0 | 0 |
| | 2% | 0 | 0 | 0 | 0 | 0 |
| | 10% | 0 | 0 | 0 | 0 | 0 |

TABLE 12b
Fomitiporia Mediterranea

| | | Growth | Growth | Growth | Growth | Growth |
|---|---|---|---|---|---|---|
| | | (cm) | (cm) | (cm) | (cm) | (cm) |
| | Tanning | after 6 | after 7 | after 8 | after 9 | after 10 |
| Product | (% w/w) | days | days | days | days | days |
| Control | | 1.7 | 2.2 | 2.7 | 3.2 | 3.6 |
| PR1 | 1% | 0 | 0 | 0 | 0 | 0 |
| | 2% | 0 | 0 | 0 | 0 | 0 |
| | 10% | 0 | 0 | 0 | 0 | 0 |
| PR2 | 1% | 0 | 0 | 0 | 0 | 0 |
| | 2% | 0 | 0 | 0 | 0 | 0 |
| | 10% | 0 | 0 | 0 | 0 | 0 |
| PR3 | 1% | 0 | 0 | 0 | 0 | 0 |
| | 2% | 0 | 0 | 0 | 0 | 0 |
| | 10% | 0 | 0 | 0 | 0 | 0 |
| PR4 | 1% | 0 | 0 | 0 | 0 | 0 |
| | 2% | 0 | 0 | 0 | 0 | 0 |
| | 10% | 0 | 0 | 0 | 0 | 0 |
| PR5 | 1% | 0 | 0 | 0 | 0 | 0 |
| | 2% | 0 | 0 | 0 | 0 | 0 |
| | 10% | 0 | 0 | 0 | 0 | 0 |

TABLE 13a
Phaeomoniella Chlamydospora

| | | Growth | Growth | Growth | Growth | Growth |
|---|---|---|---|---|---|---|
| | | (cm) | (cm) | (cm) | (cm) | (cm) |
| | Tanning | after 1 | after 2 | after 3 | after 4 | after 5 |
| Product | (% w/w) | day | days | days | days | days |
| Control | | 0 | 0 | 0 | 0.3 | 0.4 |
| PR1 | 1% | 0 | 0 | 0 | 0 | 0 |
| | 2% | 0 | 0 | 0 | 0 | 0 |
| | 10% | 0 | 0 | 0 | 0 | 0 |
| PR2 | 1% | 0 | 0 | 0 | 0 | 0 |
| | 2% | 0 | 0 | 0 | 0 | 0 |
| | 10% | 0 | 0 | 0 | 0 | 0 |
| PR3 | 1% | 0 | 0 | 0 | 0 | 0 |
| | 2% | 0 | 0 | 0 | 0 | 0 |
| | 10% | 0 | 0 | 0 | 0 | 0 |
| PR4 | 1% | 0 | 0 | 0 | 0 | 0 |
| | 2% | 0 | 0 | 0 | 0 | 0 |
| | 10% | 0 | 0 | 0 | 0 | 0 |
| PR5 | 1% | 0 | 0 | 0 | 0 | 0 |
| | 2% | 0 | 0 | 0 | 0 | 0 |
| | 10% | 0 | 0 | 0 | 0 | 0 |

TABLE 13b
Phaeomoniella Chlamydospora

| | | Growth | Growth | Growth | Growth | Growth |
|---|---|---|---|---|---|---|
| | | (cm) | (cm) | (cm) | (cm) | (cm) |
| | Tanning | after 6 | after 7 | after 8 | after 9 | after 10 |
| Product | (% w/w) | days | days | days | days | days |
| Control | | 0.6 | 0.6 | 0.9 | 1.1 | 1.1 |
| PR1 | 1% | 0 | 0 | 0 | 0 | 0 |
| | 2% | 0 | 0 | 0 | 0 | 0 |
| | 10% | 0 | 0 | 0 | 0 | 0 |
| PR2 | 1% | 0 | 0 | 0 | 0 | 0 |
| | 2% | 0 | 0 | 0 | 0 | 0 |
| | 10% | 0 | 0 | 0 | 0 | 0 |
| PR3 | 1% | 0 | 0 | 0 | 0 | 0 |
| | 2% | 0 | 0 | 0 | 0 | 0 |
| | 10% | 0 | 0 | 0 | 0 | 0 |
| PR4 | 1% | 0 | 0 | 0 | 0 | 0 |
| | 2% | 0 | 0 | 0 | 0 | 0 |
| | 10% | 0 | 0 | 0 | 0 | 0 |
| PR5 | 1% | 0 | 0 | 0 | 0 | 0 |
| | 2% | 0 | 0 | 0 | 0 | 0 |
| | 10% | 0 | 0 | 0 | 0 | 0 |

TABLE 14
Phytophthora Cinnamoni

| | | Growth | Growth | Growth | Growth | Growth | Growth |
|---|---|---|---|---|---|---|---|
| | | (cm) | (cm) | (cm) | (cm) | (cm) | (cm) |
| | Tanning | after 1 | after 2 | after 3 | after 4 | after 5 | after 6 |
| Product | (% w/w) | day | days | days | days | days | days |
| Control | | 0.7 | 2.2 | 3.8 | 5.4 | 7 | 8.5 |
| PR1 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR2 | 1% | 0.2 | 1.1 | 2.2 | 3.3 | 4.4 | 5.5 |
| | 2% | 0 | 0.2 | 0.7 | 1.3 | 1.9 | 2.5 |
| | 10% | 0 | 0 | 0 | 0 | 0 | 0 |
| PR3 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR4 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR5 | 1% | 0 | 0 | 0.5 | 1.3 | 1.9 | 2.4 |
| | 2% | 0 | 0 | 0 | 0 | 0 | 0 |
| | 10% | 0 | 0 | 0 | 0 | 0 | 0 |

TABLE 15
Phytophthora Ramorum

| | | Growth | Growth | Growth | Growth | Growth | Growth |
|---|---|---|---|---|---|---|---|
| | | (cm) | (cm) | (cm) | (cm) | (cm) | (cm) |
| | Tanning | after 1 | after 2 | after 3 | after 4 | after 5 | after 6 |
| Product | (% w/w) | day | days | days | days | days | days |
| Control | | 0 | 0 | 0.7 | 1.2 | 1.7 | 2.3 |
| PR1 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR2 | 1% | 0 | 0 | 0 | 0.6 | 1.1 | 1.6 |
| | 2% | 0 | 0 | 0 | 0 | 0 | 0 |
| | 10% | 0 | 0 | 0 | 0 | 0 | 0 |
| PR3 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR4 | 1% | 0 | 0 | 0 | 0 | 0 | 0 |
| | 2% | 0 | 0 | 0 | 0 | 0 | 0 |
| | 10% | 0 | 0 | 0 | 0 | 0 | 0 |
| PR5 | 1% | 0 | 0 | 0 | 0.3 | 0.7 | 1.1 |
| | 2% | 0 | 0 | 0 | 0 | 0 | 0 |
| | 10% | 0 | 0 | 0 | 0 | 0 | 0 |

In the following tests the growth substrate used was PDA (Potato Dextrose Agar), 3 replicates for the control not supplemented with the products and 3 replicates for each of the products at the concentration of 0.5%.

Diameter growth was measured daily for each replicate.

In the following tables, the value expressed in centimetres (cm) refers to the average growth of the 3 replicates.

TABLE 16
Botrytis cinerea

| | | Growth | Growth | Growth |
|---|---|---|---|---|
| | Tanning | (cm) | (cm) | (cm) |
| | (% | after | after | after |
| Product | w/w) | 5 days | 6 days | 7 days |
| Control | | 4.95 | 5.73 | 6.20 |
| PR1 | 0.5% | 3.25 | 4.08 | 4.95 |
| PR2 | 0.5% | 3.07 | 4.08 | 4.82 |
| PR3 | 0.5% | 0 | 0 | 0.15 |
| PR4 | 0.5% | 0.18 | 0.18 | 0.42 |
| PR5 | 0.5% | 3.23 | 3.72 | 3.90 |

TABLE 17
Colletotrichum Coccodes

| | | Growth | Growth | Growth |
|---|---|---|---|---|
| | Tanning | (cm) | (cm) | (cm) |
| | (% | after | after | after |
| Product | w/w) | 5 days | 6 days | 7 days |
| Control | | 2.88 | 3.58 | 4.25 |
| PR1 | 0.5% | 0.52 | 0.92 | 1.45 |
| PR2 | 0.5% | 1.03 | 1.12 | 1.55 |
| PR3 | 0.5% | 0.30 | 0.47 | 0.61 |
| PR4 | 0.5% | 0.67 | 0.92 | 1.35 |
| PR5 | 0.5% | 0.48 | 0.75 | 0.97 |

In the following tests, the growth substrate used was PDA (Potato Dextrose Agar), 3 replicates for the control not supplemented with the products and 3 replicates for each of the products at concentrations of 0.1% and 0.2%.

In the following tables, the value expressed in centimetres (cm) refers to the average growth of the 3 replicates.

TABLE 18
Botryosphaeria Dothidea

| Product | Tanning (% w/w) | Growth (cm) after 4 days |
|---|---|---|
| Control | | 4.68 |
| PR2 | 0.1% | 4.76 |
| PR2 | 0.2% | 4.33 |
| PR3 | 0.1% | 2.66 |
| PR3 | 0.2% | 1.68 |
| PR4 | 0.1% | 2.80 |
| PR4 | 0.2% | 2.30 |

TABLE 19
Botrytis cinerea

| Product | Tanning (% w/w) | Growth (cm) after 4 days |
|---|---|---|
| Control | | 7.85 |
| PR2 | 0.1% | 6.21 |
| PR2 | 0.2% | 5.58 |
| PR3 | 0.1% | 1.60 |
| PR3 | 0.2% | 1.30 |
| PR4 | 0.1% | 1.26 |
| PR4 | 0.2% | 0 |

TABLE 20
Fomitiporia Mediterranea

| Product | Tanning (% w/w) | Growth (cm) after 4 days |
|---|---|---|
| Control | | 1.33 |
| PR2 | 0.1% | 1.20 |
| PR2 | 0.2% | 0.90 |
| PR3 | 0.1% | 0 |
| PR3 | 0.2% | 0 |
| PR4 | 0.1% | 0 |
| PR4 | 0.2% | 0 |

TABLE 21
Fusarium Graminearum

| Product | Tanning (% w/w) | Growth (cm) after 4 days |
|---|---|---|
| Control | | 5.73 |
| PR2 | 0.1% | 5.43 |
| PR2 | 0.2% | 4.83 |
| PR3 | 0.1% | 2.78 |
| PR3 | 0.2% | 1.80 |
| PR4 | 0.1% | 3.25 |
| PR4 | 0.2% | 1.91 |

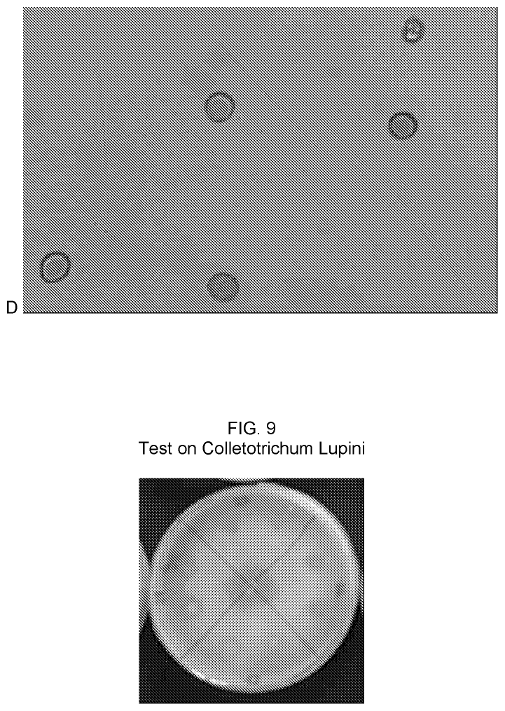

Tables 22a and 22b show instead the results of tests carried out on another fungus of agricultural interest such as Colletotrichum Lupini, an agent of severe anthracnose. For the screening of the substances to be carried out, on an agarised plate for the fungus in question, the products were diluted to concentrations of 1.25% and 5%. The fungus was cultured on a plate and was then used to inoculate new plates with the various products to be tested. All products from No. 1 to No. 40 were tested. The table shows only those where there was inhibition of fungal growth. 4 different products (1 drop of 10 μl per product, for 2 replicates each) were placed on each plate as shown in FIG. 9. The plates were then incubated for 24 hours at 26° C. After 24 hours, the “free zone” formed around each drop was measured in cm (the radius from the centre of the drop was measured). Only products that were effective were shown.

TABLE 22a
Colletotrichum Lupini (Products diluted to 5%)

| Product | Concentration | Free zone (cm) |
|---|---|---|
| Product 9 | 5% | 0.6 |
| Product 20 | 5% | 0.8 |
| Product 24 | 5% | 0.6 |
| Product 25 | 5% | 0.2 |
| Product 26 | 5% | 0.3 |
| Product 27 | 5% | 0.3 |
| Product 28 | 5% | 0.4 |
| Product 29 | 5% | 0.5 |
| Product 30 | 5% | 0.4 |
| Product 38 | 5% | 0.3 |
| Product 39 | 5% | 0.3 |
| Product 40 | 5% | 0.4 |

TABLE 22b
Colletotrichum Lupini (Products diluted to 1.25%)

| Product | Concentration | Free zone (cm) |
|---|---|---|
| Product 20 | 1.25% | 0.6 |
| Product 27 | 1.25% | 0.2 |
| Product 28 | 1.25% | 0.3 |
| Product 29 | 1.25% | 0.5 |

### Results and Discussion

Product 3 and product 4 proved to be the most effective in counteracting the mycelial growth of Botrytis Cinerea, Fusarium Graminearum, Fomitiporia Mediterranea, Phaeomoniella Chlamydospora, Phytophthora Cinnamoni, Phytophthora Ramorum, Colletotrichum Coccodes and Botryosphaeria Dothidea even at very low concentrations (0.1 and 0.2%). With regard to the pathogenic fungus Colletotrichum Lupini, the products that proved to be the most effective were product Nos. 20 and 29 (at a concentration of 1.25%) and products Nos. 9 and 20 (at a concentration of 5%).

### EXAMPLE 6: Bacteria Tests

The in vitro efficacy of some products of the present invention in inhibiting the growth of pathogenic bacteria of agricultural interest, agents of severe bacterial diseases on horticultural and other species, has been tested. The bacteria taken into consideration were:

Pseudomonas syringae pv tomato (DC 3000), Clavibacter michiganensis subsp. michiganensis (CMM) and Pseudomonas savastanoi.

At the same time, the possible inhibiting effect on nitrogen-fixing bacteria such as Azospirillum brasilense was evaluated.

For all bacteria, except for Pseudomonas savastanoi, a specific procedure was followed to identify the lowest inhibiting concentration (MIC). The method involves the use of 96-well plates for microtitration and the following operating procedure:
a) Preparation of the stock solution of the products to be tested: Starting from a product as such, a 5% stock solution (2.5 ml of product+47.5 ml of distilled water) is prepared.
b) Preparation of the bacterial inoculum:

Colonies of the bacterial species on which the products are to be tested are selected from a 24-hour culture on an agarised plate.

The top of one or more colonies is transferred to an Erlenmeyer flask containing 50 ml of BHI (Brain Heart Infusion), which is incubated at 37° C.±1 in aerobiosis until the desired concentration is reached.

Once titrated, the solution is diluted up to a concentration of 2×10⁶ UFC/ml.
c) Setting up plates for microtitration

The plates are set up as described below and as shown in Table 23:

TABLE 23
Setting up microtitration plates for MIC determination

| | 1 | 2 | 3 | 4 | 5 | 6 | 7 | 8 | 9 | 10 | 11 | 12 |
|---|---|---|---|---|---|---|---|---|---|---|---|---|
| A | 1.25% | 1.25% | 1.25% | 1.25% | 1.25% | 1.25% | 1.25% | 1.25% | 1.25% | Positive | Negative | Products |
| B | 0.62% | 0.62% | 0.62% | 0.62% | 0.62% | 0.62% | 0.62% | 0.62% | 0.62% | Control | Control | |
| C | 0.31% | 0.31% | 0.31% | 0.31% | 0.31% | 0.31% | 0.31% | 0.31% | 0.31% | | | |
| D | 0.16% | 0.16% | 0.16% | 0.16% | 0.16% | 0.16% | 0.16% | 0.16% | 0.16% | | | |
| E | 0.08% | 0.08% | 0.08% | 0.08% | 0.08% | 0.08% | 0.08% | 0.08% | 0.08% | | | |
| F | 0.04% | 0.04% | 0.04% | 0.04% | 0.04% | 0.04% | 0.04% | 0.04% | 0.04% | | | |
| G | 0.02% | 0.02% | 0.02% | 0.02% | 0.02% | 0.02% | 0.02% | 0.02% | 0.02% | | | |
| H | 0.01% | 0.01% | 0.01% | 0.01% | 0.01% | 0.01% | 0.01% | 0.01% | 0.01% | | | |

50 μl of BHI are added to all wells of the first 9 columns.

50 μl of stock solution of product 1 are added to wells A1, A2 and A3

50 μl of stock solution of product 2 are added to wells A4, A5 and A6

50 μl of stock solution of product 3 are added to wells A7, A8 and A9

50 μl are taken from each well of row A and mixed in the corresponding well of row B. These serial dilutions are repeated up to row H, resulting in the concentrations given in Table 23.

At this point, 50 μl of bacterial suspension is added to each well of the plate at the final concentration of 1×10⁶ UFC/ml.

Column No. 10 is used as a positive control (50 μl of BHI+50 μl of bacterial suspension)

Column No. 11 is used as negative control (100 μl of BHI)

Column No. 12 is used to verify the absence of bacterial contamination in the products by adding 100 μl of each stock solution of the tested products to the wells. Once set up, the plate is incubated overnight at the optimal temperature for bacterial growth. Optical density readers are used to check bacterial growth in the wells.

The results for Psudomonas syringae pv tomato (DC3000), Clavibacter michiganensis subsp. michiganensis (CMM) and Azospirillum brasilense are shown in Tables 24, 25 and 26.

TABLE 24
MIC on Psudomonas syringae pv tomato (DC3000)
and Clavibacter michiganensis subsp. michiganensis
(CMM) - Incubation temperature = 37° C.

| Product | DC3000 (%) | CMM (%) |
|---|---|---|
| Product 1 | 1.25 | 1.25 |
| Product 2 | 1.25 | 1.25 |
| Product 3 | 0.62 | 0.31 |
| Product 4 | >1.25 | 0.31 |
| Product 5 | 1.25 | 1.25 |
| Product 6 | 1.25 | >1.25 |
| Product 7 | >1.25 | >1.25 |
| Product 8 | 1.25 | >1.25 |
| Product 9 | 0.62 | 0.07 |
| Product 10 | 1.25 | 0.31 |
| Product 11 | 1.25 | 1.25 |
| Product 12 | 1.25 | >1.25 |
| Product 13 | 1.25 | >1.25 |
| Product 14 | 1.25 | 1.25 |
| Product 15 | >1.25 | >1.25 |
| Product 16 | >1.25 | 0.31 |
| Product 17 | >1.25 | >1.25 |
| Product 18 | >1.25 | >1.25 |
| Product 19 | >1.25 | 1.25 |
| Product 20 | >1.25 | 0.62 |
| Product 21 | >1.25 | >1.25 |
| Product 22 | >1.25 | >1.25 |
| Product 23 | 1.25 | >1.25 |
| Product 24 | 1.25 | 1.25 |
| Product 25 | 1.25 | >1.25 |
| Product 26 | >1.25 | >1.25 |
| Product 27 | 1.25 | 1.25 |
| Product 28 | 1.25 | 1.25 |
| Product 29 | 1.25 | 1.25 |
| Product 30 | >1.25 | >1.25 |
| Product 31 | >1.25 | 1.25 |
| Product 32 | >1.25 | >1.25 |
| Product 33 | 1.25 | 1.25 |
| Product 34 | >1.25 | >1.25 |
| Product 35 | >1.25 | >1.25 |
| Product 36 | 1.25 | 1.25 |
| Product 37 | 1.25 | >1.25 |
| Product 38 | >1.25 | >1.25 |
| Product 39 | >1.25 | 1.25 |
| Product 40 | >1.25 | 1.25 |

TABLE 25
MIC on Psudomonas syringae pv tomato (DC3000)
and Clavibacter michiganensis subsp. michiganensis
(CMM) - Incubation temperature = 26° C.

| Product | DC3000 (%) | CMM (%) |
|---|---|---|
| Product 1 | >1.25 | >1.25 |
| Product 2 | >1.25 | >1.25 |
| Product 3 | 0.62 | 0.62 |
| Product 4 | >1.25 | 0.31 |
| Product 5 | 1.25 | >1.25 |
| Product 6 | >1.25 | >1.25 |
| Product 7 | >1.25 | >1.25 |
| Product 8 | >1.25 | >1.25 |
| Product 9 | >1.25 | >1.25 |
| Product 10 | 0.62 | 0.15 |
| Product 11 | >1.25 | >1.25 |
| Product 12 | >1.25 | >1.25 |
| Product 13 | 1.25 | >1.25 |
| Product 14 | >1.25 | >1.25 |
| Product 15 | >1.25 | >1.25 |
| Product 16 | >1.25 | 0.31 |
| Product 17 | >1.25 | >1.25 |
| Product 18 | >1.25 | >1.25 |
| Product 19 | >1.25 | >1.25 |
| Product 20 | >1.25 | 0.62 |
| Product 21 | >1.25 | >1.25 |
| Product 22 | >1.25 | >1.25 |
| Product 23 | >1.25 | >1.25 |
| Product 24 | >1.25 | >1.25 |
| Product 25 | 1.25 | >1.25 |
| Product 26 | >1.25 | >1.25 |
| Product 27 | 1.25 | 1.25 |
| Product 28 | 1.25 | 1.25 |
| Product 29 | 1.25 | 1.25 |
| Product 30 | >1.25 | >1.25 |
| Product 31 | >1.25 | >1.25 |
| Product 32 | >1.25 | >1.25 |
| Product 33 | >1.25 | >1.25 |
| Product 34 | >1.25 | >1.25 |
| Product 35 | >1.25 | >1.25 |
| Product 36 | >1.25 | >1.25 |
| Product 37 | >1.25 | >1.25 |
| Product 38 | >1.25 | >1.25 |
| Product 39 | >1.25 | >1.25 |
| Product 40 | >1.25 | >1.25 |

### Results and Discussion

Products No. 3, 4, 9, 10, 16 and 20 proved to be very effective in inhibiting the bacterial growth of the pathogenic bacteria tested.

TABLE 26
MIC on Azospirillum brasilense. Incubation temperature = 35° C.

| Product | Azospirillum brasilense(%) |
|---|---|
| Product 1 | >1.25 |
| Product 2 | >1.25 |
| Product 3 | >1.25 |
| Product 4 | >1.25 |
| Product 5 | >1.25 |
| Product 6 | >1.25 |
| Product 7 | >1.25 |
| Product 8 | >1.25 |
| Product 9 | >1.25 |
| Product 10 | >1.25 |
| Product 11 | >1.25 |
| Product 12 | >1.25 |
| Product 13 | >1.25 |
| Product 14 | >1.25 |
| Product 15 | >1.25 |
| Product 16 | >1.25 |
| Product 17 | >1.25 |
| Product 18 | >1.25 |
| Product 19 | >1.25 |
| Product 20 | >1.25 |
| Product 21 | >1.25 |
| Product 22 | >1.25 |
| Product 23 | >1.25 |
| Product 24 | >1.25 |
| Product 25 | >1.25 |
| Product 26 | >1.25 |
| Product 27 | >1.25 |
| Product 28 | >1.25 |
| Product 29 | >1.25 |
| Product 30 | >1.25 |
| Product 31 | >1.25 |
| Product 32 | >1.25 |
| Product 33 | <1.25 |
| Product 34 | >1.25 |
| Product 35 | >1.25 |
| Product 36 | >1.25 |
| Product 37 | >1.25 |
| Product 38 | <1.25 |
| Product 39 | >1.25 |
| Product 40 | >1.25 |

### Results and Discussion

All products, except for products Nos. 33 and 38, showed no inhibiting effect on Azospirillum brasilense. This data is very significant and important since this is a bacterium that is able to fix nitrogen in the presence of low oxygen levels making it a micro-aerobic diazotrope, thus promoting plant growth.

It has therefore been demonstrated that the products, while having significant efficacy in inhibiting both mycelial and bacterial growth of fungi and pathogenic bacteria, have no adverse effect on bacteria essential for physiological plant growth.

With regard to the test on Pseudomonas savastanoi, a Gram-negative bacterium responsible for “olive wart-like disease”, all the products of the present invention were tested using the “paper disc” mode. For the screening to be carried out, the products were tested as such, and at concentrations of 0.1 and 0.5%, using sterile deionised water for dilutions.

The bacterium was placed in liquid culture on LB medium (Lysogenia broth) and then was grown on a plate with TSA agar medium (tryptic soy agar). 3 blotting paper discs were then placed on each plate, which were carefully soaked in each product at different concentrations.

The plates were then incubated for 24 hours at 37° C. The “free zone” formed around each disc was measured in mm. The test results are shown in Table 27.

TABLE 27
Pseudomonas savastanoi

| | | | Product |
|---|---|---|---|
| | Undiluted products | Product | concentration |
| | as such | concentration 0.5% | 0.1% |
| Product | Free zone (mm) | Free zone (mm) | Free zone (mm) |
| 1 | 6 | 3 | 0 |
| 2 | 1 | 0.5 | 0 |
| 3 | 3 | 0.5 | 0 |
| 4 | 3 | 3 | 0 |
| 5 | 6 | 3 | 1 |
| 6 | 3 | 1 | 1 |
| 7 | 3 | 1 | 1.5 |
| 8 | 4 | 0 | 2 |
| 9 | 12 | 1 | 1 |
| 10 | 7 | 0.5 | 1 |
| 11 | 0 | 0 | 0 |
| 12 | 0 | 1 | 0.5 |
| 13 | 3.5 | 1.5 | 1.5 |
| 14 | 2 | 1 | 3 |
| 15 | 1 | 0 | 1 |
| 16 | 2.5 | 0 | 0.5 |
| 17 | 0 | 1 | 2 |
| 18 | 0 | 0 | 2 |
| 19 | 3 | 0 | 0 |
| 20 | 4 | 0 | 1.5 |
| 21 | 5 | 0 | 0 |
| 22 | 0 | 0 | 0 |
| 23 | 2 | 0 | 0 |
| 24 | 1.5 | 0 | 3 |
| 25 | 2 | 0 | 3 |
| 26 | 0.5 | 0 | 0 |
| 27 | 5 | 0 | 2 |
| 28 | 2 | 1 | 1 |
| 29 | 2 | 3 | 0 |
| 30 | 4 | 1 | 0 |
| 31 | 2 | 1 | 0 |
| 32 | 1 | 0 | 0 |
| 33 | 2 | 0 | 0 |
| 34 | 1 | 0.5 | 0 |
| 35 | 2 | 0 | 0 |
| 36 | 4 | 0 | 0 |
| 37 | 3 | 0 | 0 |
| 38 | 3 | 0 | 0 |
| 39 | 4 | 1 | 0 |
| 40 | 0 | 1.5 | 0.5 |

### Results and Discussion

Product No. 9 at maximum concentration shows a significant antibacterial effect by inhibiting the growth of 12 mm.

When lowering the concentration there are numerous products that show an inhibiting effect of bacterial growth. These are products Nos. 1, 4, 5, 14, 24, 25 and 29.

### EXAMPLE 7: Field Tests

Three field tests on vines were carried out to evaluate the possible efficacy of the products as such of the present invention and/or in association with fungicides as antifungals.

### Example 7.1

The first test was carried out on vines in greenhouse with artificial inoculum of the pathogen (Plasmopara Viticola) on plants treated with Products Nos. 2, 3 and 4 at concentrations of 0.1 and 0.2%. The data obtained were compared with the data obtained by treating another group of plants with Kocide® 3000 at the label dose (150 g/100 L of water).

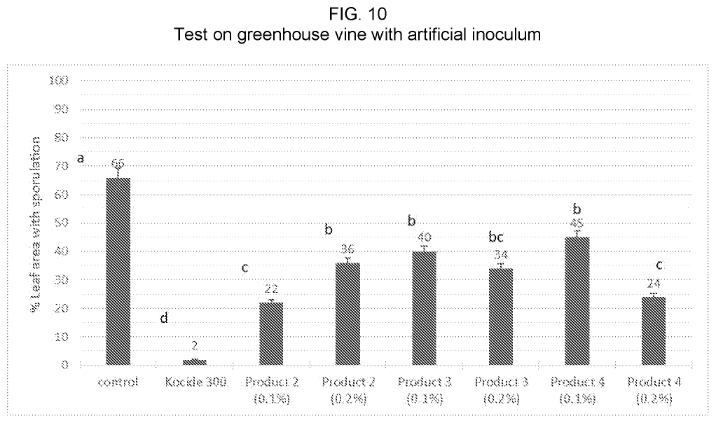

The results of such test are shown in FIG. 10.

### Results and Discussion

Plants treated with Kocide® 3000 showed the lowest percentage of leaves with sporulation (−96% compared to the control group), while products Nos. 2 and 4 at concentrations of 0.1% and 0.2%, respectively, proved to be effective in decreasing leaf sporulation by about 66% and 63%, respectively.

### Example 7.2

The test was set up in a test centre on vine on field to assess the efficacy of the products of the present invention alone at different concentrations (500 ml/hl of water, 1000 ml/hl of water and 1500 ml/hl of water) and in association with Cuproxat (product based on copper metal 190 g/L in the form of tribasic copper sulphate) and Curzate (product based on cymoxanil, 4.2 g, and copper metal, 39.75 g, in the form of copper oxychloride).

The following tables show the test specifications:

TABLE 28
Description of the crop

| | |
|---|---|
| Species | Vitis Vinifera |
| Variety | Aglianico |
| Distance between the rows of vines | 2.00 m |
| Distance between plants within the row | 1.50 m |
| Soil moisture | Normal |

TABLE 29
Description of the fungi

| | |
|---|---|
| 1 | Plasmopara Viticola |
| 2 | Botryotinia fuckeliana |

TABLE 30
Description of the site

| Treated area | 21 | m² |
|---|---|---|
| Number of treatments | 10 | |
| Replicates | 4 | |
| Width of the treated area (per treatment) | 2 | m |
| Length of the treated area (per treatment) | 10.5 | m |

TABLE 31
Soil characteristics

| | |
|---|---|
| % of sand | 43.5 |
| % of silt | 39 |
| % of clay | 17.5 |
| pH | 6.4 |
| % OM (Organic Matter) | 2 |

TABLE 32
Methods for applying the product

| Application method | Foliar spray | |
|---|---|---|
| Application equipment | Knapsack | |
| Operating pressure | 2 BAR | |
| Nozzle type | Flat-Fan | |
| Nozzle size | N-KA-15R | |
| Space between nozzles | 4 | cm |
| Nozzle rows | 2 | |
| Nozzle flow rate | 2506.7 | ml/min |
| Carrier | Water | |
| Sprayed volume | 1000 | L/ha |

| | |
|---|---|
| pH of sprayed solution | 6.2 |

TABLE 33
Description of treatments

| | | Product | | | | | |
|---|---|---|---|---|---|---|---|
| Treatment | | concentration | | | Final | | |
| No. | Treatment name | T.Q. | | Dosage | concentration | | Sprayed volume |
| 1 | Control | — | | | | | |
| 2 | Product 1 | 900 | g/L | 500 ml/100 L | 4500 | g/ha | 1000 L/ha |
| | | | | of water | | | |
| 3 | Product 1 | 900 | g/L | 1000 ml/100 L | 9000 | g/ha | 1000 L/ha |
| | | | | of water | | | |
| 4 | Product 1 | 900 | g/L | 1500 ml/100 L | 13500 | g/ha | 1000 L/ha |
| | | | | of water | | | |
| 5 | Product 1 + | 900 | g/L | 500 ml/100 L | 4500 | g/ha | 1000 L/ha |
| | Cuproxat S.D.I. | | | of water | | | |
| | | 195 | g/L | 300 ml/100 L | 585 | g/ha | 1000 L/ha |
| | | | | of water | | | |
| 6 | Product 1 + | 900 | g/L | 1000 ml/100 L | 9000 | g/ha | 1000 L/ha |
| | Cuproxat S.D.I. | | | of water | | | |
| | | 195 | g/L | 300 ml/100 L | 585 | g/ha | 1000 L/ha |
| | | | | of water | | | |
| 7 | Product 1 + | 900 | g/L | 1500 ml/100 L | 13500 | g/ha | 1000 L/ha |
| | Cuproxat S.D.I. | | | of water | | | |
| | | 195 | g/L | 300 ml/100 L | 585 | g/ha | 1000 L/ha |
| | | | | of water | | | |
| 8 | Product 1 + | 900 | g/L | 500 ml/100 L | 4500 | g/ha | 1000 L/ha |
| | Curzate | | | of water | | | |
| | | 200 | g/Kg | 60 g/100 L | 120 | g/ha | 1000 L/ha |
| | | | | of water | | | |
| 9 | Product 1 + | 900 | g/L | 1000 ml/100 L | 9000 | g/ha | 1000 L/ha |
| | Curzate | | | of water | | | |
| | | 200 | g/Kg | 60 g/100 L | 120 | g/ha | 1000 L/ha |
| | | | | of water | | | |
| 10 | Product 1 + | 900 | g/L | 1500 ml/100 L | 13500 | g/ha | 1000 L/ha |
| | Curzate | | | of water | | | |
| | | 200 | g/Kg | 60 g/100 L | 120 | g/ha | 1000 L/ha |
| | | | | of water | | | |

TABLE 34
Layout of the experimental site (treatments)

| | | | |
|---|---|---|---|
| 10 | 8 | 5 | 3 |
| 9 | 7 | 4 | 2 |
| 8 | 6 | 3 | 1 |
| 7 | 5 | 2 | 10 |
| 6 | 4 | 1 | 9 |
| 5 | 3 | 10 | 8 |
| 4 | 2 | 9 | 7 |
| 3 | 1 | 8 | 6 |
| 2 | 10 | 7 | 5 |
| 1 | 9 | 6 | 4 |

TABLE 35
Layout legend Experimental test site

| Treatment | Description | Dosage |
|---|---|---|
| 1 | Control | |
| 2 | Product 1 | 500 ml/hl |
| 3 | Product 1 | 1000 ml/hl |
| 4 | Product 1 | 1500 ml/hl |
| 5 | Product 1 & Cuproxat | 500 ml/hl + 300 ml/hl |
| 6 | Product 1 & Cuproxat | 1000 ml/hl + 300 ml/hl |
| 7 | Product 1 & Cuproxat | 1500 ml/hl + 300 ml/hl |
| 8 | Product 1 & Curzate | 500 ml/hl + 60 g/hl |
| 9 | Product 1 & Curzate | 1000 ml/hl + 60 g/hl |
| 10 | Product 1 & Curzate | 1500 ml/hl + 60 g/hl |

The following parameters were assessed in the test:
Phytotoxicity: PHYGEN
Vigour: VIGOR
Number of leaves damaged by the disease on 140 leaves per treatment: COPLPA
Percentage of damaged leaves: PESINC

The results are shown in the Tables below:

TABLE 36
Evaluation of the Phytotoxicity of the treatments

| Treatment date | 10/Jun./2016 | 12/Jun./2016 | 14/Jun./2016 | 16/Jun./2016 | 17/Jun./2016 | 19/Jun./2016 |
|---|---|---|---|---|---|---|
| Analysed parameter | PHYGEN | PHYGEN | PHYGEN | PHYGEN | PHYGEN | PHYGEN |
| Unit of measurement | 0-100 | 0-100 | 0-100 | 0-100 | 0-100 | 0-100 |
| Control | 0.00a | 0.00a | 0.00a | 0.00a | 0.00a | 0.00a |
| Treatment 2 | 0.00a | 0.00a | 0.00a | 0.00a | 0.00a | 0.00a |
| Treatment 3 | 0.00a | 0.00a | 0.00a | 0.00a | 0.00a | 0.00a |
| Treatment 4 | 0.00a | 0.00a | 0.00a | 0.00a | 0.00a | 0.00a |
| Treatment 5 | 0.00a | 0.00a | 0.00a | 0.00a | 0.00a | 0.00a |
| Treatment 6 | 0.00a | 0.00a | 0.00a | 0.00a | 0.00a | 0.00a |
| Treatment 7 | 0.00a | 0.00a | 0.00a | 0.00a | 0.00a | 0.00a |
| Treatment 8 | 0.00a | 0.00a | 0.00a | 0.00a | 0.00a | 0.00a |
| Treatment 9 | 0.00a | 0.00a | 0.00a | 0.00a | 0.00a | 0.00a |
| Treatment 10 | 0.00a | 0.00a | 0.00a | 0.00a | 0.00a | 0.00a |

TABLE 37
Evaluation of the Phytotoxicity of the treatments

| Treatment date | 21/Jun./2016 | 23/Jun./2016 | 24/Jun./2016 | 26/Jun./2016 | 28/Jun./2016 | 30/Jun./2016 |
|---|---|---|---|---|---|---|
| Analysed parameter | PHYGEN | PHYGEN | PHYGEN | PHYGEN | PHYGEN | PHYGEN |
| Unit of measurement | 0-100 | 0-100 | 0-100 | 0-100 | 0-100 | 0-100 |
| Control | 0.00a | 0.00a | 0.00a | 0.00a | 0.00a | 0.00a |
| Treatment 2 | 0.00a | 0.00a | 0.00a | 0.00a | 0.00a | 0.00a |
| Treatment 3 | 0.00a | 0.00a | 0.00a | 0.00a | 0.00a | 0.00a |
| Treatment 4 | 0.00a | 0.00a | 0.00a | 0.00a | 0.00a | 0.00a |
| Treatment 5 | 0.00a | 0.00a | 0.00a | 0.00a | 0.00a | 0.00a |
| Treatment 6 | 0.00a | 0.00a | 0.00a | 0.00a | 0.00a | 0.00a |
| Treatment 7 | 0.00a | 0.00a | 0.00a | 0.00a | 0.00a | 0.00a |
| Treatment 8 | 0.00a | 0.00a | 0.00a | 0.00a | 0.00a | 0.00a |
| Treatment 9 | 0.00a | 0.00a | 0.00a | 0.00a | 0.00a | 0.00a |
| Treatment 10 | 0.00a | 0.00a | 0.00a | 0.00a | 0.00a | 0.00a |

TABLE 38
Evaluation of the Phytotoxicity of the treatments

| | Treatment date | | | |
|---|---|---|---|---|
| | 1 Jul. 2016 | 3 Jul. 2016 | 5 Jul. 2016 | 7 Jul. 2016 |
| | Analysed parameter | | | |
| | PHYGEN | PHYGEN | PHYGEN | PHYGEN |
| | Unit of measurement | | | |
| | 0-100 | 0-100 | 0-100 | 0-100 |
| Control | 0.00a | 0.00a | 0.00a | 0.00a |
| Treatment 2 | 0.00a | 0.00a | 0.00a | 0.00a |
| Treatment 3 | 0.00a | 0.00a | 0.00a | 0.00a |
| Treatment 4 | 0.00a | 0.00a | 0.00a | 0.00a |
| Treatment 5 | 0.00a | 0.00a | 0.00a | 0.00a |
| Treatment 6 | 0.00a | 0.00a | 0.00a | 0.00a |
| Treatment 7 | 0.00a | 0.00a | 0.00a | 0.00a |
| Treatment 8 | 0.00a | 0.00a | 0.00a | 0.00a |
| Treatment 9 | 0.00a | 0.00a | 0.00a | 0.00a |
| Treatment 10 | 0.00a | 0.00a | 0.00a | 0.00a |

TABLE 39
Vigour assessment

| Treatment date | 16/Jun./2016 | 23/Jun./2016 | 30/Jun./2016 | 14/Jul./2016 |
|---|---|---|---|---|
| Analysed parameter | VIGOR | VIGOR | VIGOR | VIGOR |
| Unit of measurement | 0-10 | 0-10 | 0-10 | 0-10 |
| Control | 10.00a | 10.00a | 10.00a | 9.63a |
| Treatment 2 | 10.00a | 10.00a | 10.00a | 9.63a |
| Treatment 3 | 10.00a | 10.00a | 10.00a | 9.75a |
| Treatment 4 | 10.00a | 10.00a | 10.00a | 10.00a |
| Treatment 5 | 10.00a | 10.00a | 10.00a | 10.00a |
| Treatment 6 | 10.00a | 10.00a | 10.00a | 10.00a |
| Treatment 7 | 10.00a | 10.00a | 10.00a | 10.00a |
| Treatment 8 | 10.00a | 10.00a | 10.00a | 10.00a |
| Treatment 9 | 10.00a | 10.00a | 10.00a | 10.00a |
| Treatment 10 | 10.00a | 10.00a | 10.00a | 10.00a |

TABLE 40
Assessment of Number of damaged leaves

| | Treatment date | | | |
|---|---|---|---|---|
| | 16 Jun. 2016 | 23 Jun. 2016 | 30 Jun. 2016 | 14 Jun. 2016 |
| | Analysed parameter | | | |
| | COPLPA | COPLPA | COPLPA | COPLPA |
| | Unit of measurement | | | |
| | Number | Number | Number | Number |
| Control | 36.50 a | 42.00 a | 50.00 a | 59.50 a |
| Treatment 2 | 34.50 a | 38.50 ab | 44.50 b | 52.25 b |
| Treatment 3 | 33.75 a | 37.75 ab | 45.50 b | 48.75 b |
| Treatment 4 | 32.75 a | 35.50 b | 39.50 b | 44.50 b |
| Treatment 5 | 21.25 b | 22.25 c | 25.50 c | 25.25 c |
| Treatment 6 | 20.00 b | 20.50 c | 21.50 c | 21.50 c |
| Treatment 7 | 19.50 b | 19.50 c | 21.00 c | 20.50 c |
| Treatment 8 | 20.00 b | 21.25 c | 22.50 c | 24.25 c |
| Treatment 9 | 19.25 b | 18.75 c | 19.25 c | 18.00 c |
| Treatment 10 | 18.25 b | 18.25 c | 18.25 c | 16.25 c |

TABLE 41
Percentage of damaged leaves

| | Treatment date | | | |
|---|---|---|---|---|
| | 16 Jun. 2016 | 23 Jun. 2016 | 30 Jun. 2016 | 14 Jul. 2016 |
| | Analysed parameter | | | |
| | PESINC | PESINC | PESINC | PESINC |
| | Unit of measurement | | | |
| | % | % | % | % |
| Control | 26.08 a | 30.00 a | 35.73 a | 42.50 a |
| Treatment 2 | 24.63 a | 27.50 ab | 31.80 ab | 37.33 b |
| Treatment 3 | 24.10 a | 26.95 ab | 30.35 b | 34.85 b |
| Treatment 4 | 23.38 a | 25.38 ab | 28.23 b | 31.78 b |
| Treatment 5 | 15.18 b | 15.88 c | 18.23 c | 18.03 c |
| Treatment 6 | 14.30 b | 14.65 c | 15.35 c | 15.35 c |
| Treatment 7 | 13.95 b | 13.95 c | 15.00 c | 14.63 c |
| Treatment 8 | 14.30 b | 15.20 c | 16.08 c | 17.33 c |
| Treatment 9 | 13.75 b | 13.40 c | 13.57 c | 12.85 c |
| Treatment 10 | 13.05 b | 13.05 c | 13.05 c | 11.63 c |

### Results and Comments

The product at different doses of use is well miscible with water and therefore does not cause any administration problems. Even with Copper based products, the product is mixed homogeneously, allowing homogeneous administration on the plants.

No phytotoxic effects caused by the administration of the product were observed at all doses tested. Therefore, this allows the product to be used up to a dose of 1500 m1/100 L of water.

Treating plants with the product as is significantly improves the severity and incidence of the disease caused by Plasmopara viticola. In fact, as regards the number of damaged leaves, a reduction is observed, compared to the control group, ranging from 12 to 25% in the groups treated with 500 m1, 1000 ml and 1500 ml of product No.1 per 100 L of water.

Combinations between product No. 1 and copper based products (at label dose) proved to be successful and this may mean a possible synergy between the products, allowing a reduction in the dosage of copper based products.

This verification was covered by the test described in Example 7.3, which was set precisely to verify whether the mixture between product 1 and copper based products (at half the label dose) is as effective as copper-based products at full label dose.

### Example 7.3

The test was set up in a test centre on vine on field to assess the efficacy of the products of the present invention at different concentrations (500 ml/hl of water, 1000 ml/hl of water and 1500 ml/hl of water) in association with Cuproxat (product based on copper metal 190 g/L in the form of tribasic copper sulphate) and Curzate (product based on cymoxanil, 4.2 g, and copper metal, 39.75 g, in the form of copper oxychloride) compared to copper based products used as such at a full label dose.

The following tables show the test specifications:

TABLE 42
Description of the crop

| | |
|---|---|
| Species | Vitis Vinifera |
| Variety | Aglianico |
| Distance between the rows of vines | 2.00 m |
| Distance between plants within the row | 1.50 m |
| Soil moisture | Normal |

TABLE 43
Description of the fungi

| | |
|---|---|
| 1 | Plasmopara Viticola |
| 2 | Botryotinia fuckeliana |

TABLE 44
Description of the site

| Treated area | 21 | m² |
|---|---|---|
| Number of treatments | 10 | |
| Replicates | 4 | |
| Width of the treated area (per treatment) | 2 | m |
| Length of the treated area (per treatment) | 10.5 | m |

TABLE 45
Soil characteristics

| | |
|---|---|
| % of sand | 43.5 |
| % of silt | 39 |
| % of clay | 17.5 |
| pH | 6.4 |
| % OM (Organic Matter) | 2 |

TABLE 46
Methods for applying the product

| Application method | Foliar spray | |
|---|---|---|
| Application equipment | Knapsack | |
| Operating pressure | 2 BAR | |
| Nozzle type | Flat-Fan | |
| Nozzle size | N-KA-15R | |
| Space between nozzles | 4 | cm |
| Nozzle rows | 2 | |
| Nozzle flow rate | 2506.7 | ml/min |
| Carrier | Water | |
| Sprayed volume | 1000 | L/ha |

| | |
|---|---|
| pH of sprayed solution | 6.2 |

TABLE 47
Description of treatments

| | | Product | | | | | |
|---|---|---|---|---|---|---|---|
| Treatment | Treatment | concentration | | | Final | | Sprayed |
| No. | name | T.Q. | | Dosage | concentration | | volume |
| 1 | Control | — | | | | | |
| 2 | Cuproxat | 195 | g/L | 300 ml/100 L | 585 | g/ha | 1000 L/ha |
| | S.D.I. | | | of water | | | |
| 3 | Curzate | 200 | g/Kg | 60 g/100 L | 120 | g/ha | 1000 L/ha |
| | | | | of water | | | |
| 4 | Product 1 + | 900 | g/L | 500 ml/100 L | 4500 | g/ha | 1000 L/ha |
| | Cuproxat | | | of water | | | |
| | S.D.I. | 195 | g/L | 150 ml/100 L | 293 | g/ha | 1000 L/ha |
| | | | | of water | | | |
| 5 | Product 1 + | 900 | g/L | 1000 ml/100 L | 9000 | g/ha | 1000 L/ha |
| | Cuproxat | | | of water | | | |
| | S.D.I. | 195 | g/L | 150 ml/100 L | 293 | g/ha | 1000 L/ha |
| | | | | of water | | | |
| 6 | Product 1 + | 900 | g/L | 1500 ml/100 L | 13500 | g/ha | 1000 L/ha |
| | Cuproxat | | | of water | | | |
| | S.D.I. | 195 | g/L | 150 ml/100 L | 293 | g/ha | 1000 L/ha |
| | | | | of water | | | |
| 7 | Product 1 + | 900 | g/L | 500 ml/100 L | 4500 | g/ha | 1000 L/ha |
| | Curzate | | | of water | | | |
| | | 200 | g/Kg | 30 g/100 L | 60 | g/ha | 1000 L/ha |
| | | | | of water | | | |
| 8 | Product 1 + | 900 | g/L | 1000 ml/100 L | 9000 | g/ha | 1000 L/ha |
| | Curzate | | | of water | | | |
| | | 200 | g/Kg | 30 g/100 L | 60 | g/ha | 1000 L/ha |
| | | | | of water | | | |
| 9 | Product 1 + | 900 | g/L | 1500 ml/100 L | 13500 | g/ha | 1000 L/ha |
| | Curzate | | | of water | | | |
| | | 200 | g/Kg | 30 g/100 L | 60 | g/ha | 1000 L/ha |
| | | | | of water | | | |

TABLE 48
Layout of the experimental site (treatments)

| | | | |
|---|---|---|---|
| 9 | 7 | 5 | 3 |
| 8 | 6 | 4 | 2 |
| 7 | 5 | 3 | 1 |
| 6 | 4 | 2 | 9 |
| 5 | 3 | 1 | 8 |
| 4 | 2 | 9 | 7 |
| 3 | 1 | 8 | 6 |
| 2 | 9 | 7 | 5 |
| 1 | 8 | 6 | 4 |

TABLE 49
Layout legend Experimental test site

| Treatment | Description | Dosage |
|---|---|---|
| 1 | Control | |
| 2 | Cuproxat S.D.A | 300 ml/hl |
| 3 | Curzate | 60 g/hl |
| 4 | Product 1 & Cuproxat | 500 ml/hl + 150 ml/hl |
| 5 | Product 1 & Cuproxat | 1000 ml/hl + 150 ml/hl |
| 6 | Product 1 & Cuproxat | 1500 ml/hl + 150 ml/hl |
| 7 | Product 1 & Curzate | 500 ml/hl + 30 g/hl |
| 8 | Product 1 & Curzate | 1000 ml/hl + 30 g/hl |
| 9 | Product 1 & Curzate | 1500 ml/hl + 30 g/hl |

The following parameters were assessed in the test:
Phytotoxicity: PHYGEN
Vigour: VIGOR
Number of leaves damaged by the disease on 140 leaves per treatment: COPLPA
Percentage of damaged leaves: PESINC

The results are shown in the tables below:

TABLE 50
Evaluation of the Phytotoxicity of the treatments

| Treatment date | 5/Aug./2016 | 7/Aug./2016 | 9/Aug./2016 | 11/Aug./2016 | 12/Aug./2016 | 14/Aug./2016 |
|---|---|---|---|---|---|---|
| Analysed parameter | PHYGEN | PHYGEN | PHYGEN | PHYGEN | PHYGEN | PHYGEN |
| Unit of measurement | 0-100 | 0-100 | 0-100 | 0-100 | 0-100 | 0-100 |
| Control | 0.00a | 0.00a | 0.00a | 0.00a | 0.00a | 0.00a |
| Treatment 2 | 0.00a | 0.00a | 0.00a | 0.00a | 0.00a | 0.00a |
| Treatment 3 | 0.00a | 0.00a | 0.00a | 0.00a | 0.00a | 0.00a |
| Treatment 4 | 0.00a | 0.00a | 0.00a | 0.00a | 0.00a | 0.00a |
| Treatment 5 | 0.00a | 0.00a | 0.00a | 0.00a | 0.00a | 0.00a |
| Treatment 6 | 0.00a | 0.00a | 0.00a | 0.00a | 0.00a | 0.00a |
| Treatment 7 | 0.00a | 0.00a | 0.00a | 0.00a | 0.00a | 0.00a |
| Treatment 8 | 0.00a | 0.00a | 0.00a | 0.00a | 0.00a | 0.00a |
| Treatment 9 | 0.00a | 0.00a | 0.00a | 0.00a | 0.00a | 0.00a |

TABLE 51
Evaluation of the Phytotoxicity of the treatments

| Treatment date | 16/Aug./2016 | 18/Aug./2016 | 19/Aug./2016 | 21/Aug./2016 | 23/Aug./2016 | 25/Aug./2016 |
|---|---|---|---|---|---|---|
| Analysed parameter | PHYGEN | PHYGEN | PHYGEN | PHYGEN | PHYGEN | PHYGEN |
| Unit of measurement | 0-100 | 0-100 | 0-100 | 0-100 | 0-100 | 0-100 |
| Control | 0.00a | 0.00a | 0.00a | 0.00a | 0.00a | 0.00a |
| Treatment 2 | 0.00a | 0.00a | 0.00a | 0.00a | 0.00a | 0.00a |
| Treatment 3 | 0.00a | 0.00a | 0.00a | 0.00a | 0.00a | 0.00a |
| Treatment 4 | 0.00a | 0.00a | 0.00a | 0.00a | 0.00a | 0.00a |
| Treatment 5 | 0.00a | 0.00a | 0.00a | 0.00a | 0.00a | 0.00a |
| Treatment 6 | 0.00a | 0.00a | 0.00a | 0.00a | 0.00a | 0.00a |
| Treatment 7 | 0.00a | 0.00a | 0.00a | 0.00a | 0.00a | 0.00a |
| Treatment 8 | 0.00a | 0.00a | 0.00a | 0.00a | 0.00a | 0.00a |
| Treatment 9 | 0.00a | 0.00a | 0.00a | 0.00a | 0.00a | 0.00a |

TABLE 52
Evaluation of the Phytotoxicity of the treatments

| | Treatment date | | | |
|---|---|---|---|---|
| | 26 Aug. | 28 Aug. | 30 Aug. | 1 Sep. |
| | 2016 | 2016 | 2016 | 2016 |
| | Analysed parameter | | | |
| | PHYGEN | PHYGEN | PHYGEN | PHYGEN |
| | Unit of measurement | | | |
| | 0-100 | 0-100 | 0-100 | 0-100 |
| Control | 0.00a | 0.00a | 0.00a | 0.00a |
| Treatment 2 | 0.00a | 0.00a | 0.00a | 0.00a |
| Treatment 3 | 0.00a | 0.00a | 0.00a | 0.00a |
| Treatment 4 | 0.00a | 0.00a | 0.00a | 0.00a |
| Treatment 5 | 0.00a | 0.00a | 0.00a | 0.00a |
| Treatment 6 | 0.00a | 0.00a | 0.00a | 0.00a |
| Treatment 7 | 0.00a | 0.00a | 0.00a | 0.00a |
| Treatment 8 | 0.00a | 0.00a | 0.00a | 0.00a |
| Treatment 9 | 0.00a | 0.00a | 0.00a | 0.00a |

TABLE 53
Vigour assessment

Treatment date

| | | | |
|---|---|---|---|
| 11 Aug. | 18 Aug. | 25 Aug. | 8 Sep. |
| 2016 | 2016 | 2016 | 2016 |

Analysed parameter

| | | | |
|---|---|---|---|
| VIGOR | VIGOR | VIGOR | VIGOR |

Unit of measurement

| | 0-10 | 0-10 | 0-10 | 0-10 |
|---|---|---|---|---|
| Control | 10.00a | 10.00a | 10.00a | 9.25b |
| Treatment 2 | 10.00a | 10.00a | 10.00a | 10.00a |
| Treatment 3 | 10.00a | 10.00a | 10.00a | 10.00a |
| Treatment 4 | 10.00a | 10.00a | 10.00a | 10.00a |
| Treatment 5 | 10.00a | 10.00a | 10.00a | 10.00a |
| Treatment 6 | 10.00a | 10.00a | 10.00a | 10.00a |
| Treatment 7 | 10.00a | 10.00a | 10.00a | 10.00a |
| Treatment 8 | 10.00a | 10.00a | 10.00a | 10.00a |
| Treatment 9 | 10.00a | 10.00a | 10.00a | 10.00a |

TABLE 54
Assessment of number of damaged leaves

| | Treatment date | | | |
|---|---|---|---|---|
| | 11 Aug. | 18 Aug. | 25 Aug. | 8 Sep. |
| | 2016 | 2016 | 2016 | 2016 |
| | Analysed parameter | | | |
| | COPLPA | COPLPA | COPLPA | COPLPA |
| | Unit of measurement | | | |
| | Number | Number | Number | Number |
| Control | 76.75a | 88.00a | 95.00a | 106.75a |
| Treatment 2 | 51.75 b | 56.50 b | 56.50a | 65.25 b |
| Treatment 3 | 50.00 b | 54.00 b | 53.50 b | 61.25 b |
| Treatment 4 | 57.75 b | 63.50 b | 63.25 b | 74.75 b |
| Treatment 5 | 56.00 b | 61.75 b | 62.25 b | 72.00 b |
| Treatment 6 | 54.25 b | 59.25 b | 59.50 b | 67.75 b |
| Treatment 7 | 54.75 b | 60.75 b | 61.25 b | 70.75 b |
| Treatment 8 | 52.75 b | 58.25 b | 58.25 b | 67.00 b |
| Treatment 9 | 51.00 b | 56.00 b | 54.50 b | 62.25 b |

TABLE 55
Percentage of damaged leaves

| | Treatment date | | | |
|---|---|---|---|---|
| | 11 Aug. | 18 Aug. | 25 Aug. | 8 Sep. |
| | 2016 | 2016 | 2016 | 2016 |
| | Analysed parameter | | | |
| | PESINC | PESINC | PESINC | PESINC |
| | Unit of measurement | | | |
| | % | % | % | % |
| Control | 54.83a | 62.85a | 67.88a | 76.25a |
| Treatment 2 | 36.98 b | 40.35 b | 40.35 b | 46.60 b |
| Treatment 3 | 35.73 b | 38.55 b | 38.23 b | 43.75 b |
| Treatment 4 | 41.23 b | 45.35 b | 45.18 b | 53.40 b |
| Treatment 5 | 39.98 b | 44.13 b | 44.48 b | 51.43 b |
| Treatment 6 | 38.75 b | 42.33 b | 42.50 b | 48.40 b |
| Treatment 7 | 39.13 b | 43.38 b | 43.75 b | 50.53 b |
| Treatment 8 | 37.68 b | 41.63 b | 41.63 b | 47.85 b |
| Treatment 9 | 36.43 b | 39.98 b | 38.93 b | 44.48 b |

### Results and Comments

The product at different doses of use is well miscible with copper based products, allowing a homogeneous delivery on the plants.

No phytotoxic effects caused by the delivery of the product were observed at all doses tested. Therefore, this allows the product to be used up to a dose of 1500 ml/100 L of water.

The two copper based products (at label dose) showed the highest efficacy in treating the disease caused by Plasmopara viticola, reducing the disease incidence by about 38% for Cuproxat and by about 43% for Curzate.

Mixtures formed by Product 1 at a dosage of 1500 ml/hl water in association with copper based products used at half the label dosage also showed high efficacy. In fact, a reduction in the incidence of the disease (Number of damaged leaves) by around 42% is observed in treatment No. 9 (Product 1: 1500 ml/hl+Curzate: 30 g/hl of water).

The value of reduction of the damaged leaves is practically the same as in treatment No. 3, thus suggesting a powerful synergistic effect between the two products. Mixing product 1 with copper based products therefore allows the use of copper based products to be reduced by 50%, thus meeting the new agricultural regulations that require a reduction in the use of copper.

1. An agricultural and/or forestry method comprising administering to a plant organism a mixture comprising or consisting of glycerol 5-90%, and glycerides of one or more organic acids 10-95% where the % are by weight with respect to the total mixture.

2. The agricultural and/or forestry method according to claim 1 in which said one or more organic acids are selected from the group consisting of C₁-C₁₂ and C₁₆-C₂₀ acids and mixtures thereof.

3. The agricultural and/or forestry method according to claim 2 wherein said one or more organic acids are selected from the group the consisting of formic acid, acetic acid, propionic acid, butyric acid, isobutyric acid, valeric acid, caproic acid, heptanoic acid, caprylic, nonanoic acid, capric acid, undecanoic acid, lauric acid, fatty acids from soybean oil, oxalic acid, adipic acid, succinic acid, citric acid, tartaric acid benzoic acid, cinnamic acid salicylic acid, fumaric acid, gluconic acid, azelaic and mixtures thereof.

4. The agricultural and/or forestry method according to claim 3 wherein said one or more organic acids are selected from the group consisting of propionic acid, butyric acid, isobutyric acid, valeric acid, caproic acid, heptanoic acid, caprylic acid, nonanoic acid, capric acid, undecanoic acid, lauric acid, soybean oil fatty acids and mixtures thereof.

5. The agricultural and/or forestry method according to claim 1 wherein the mixture comprises monoglycerides at 10-90%, preferably at 40-90%.

6. The agricultural and/or forestry method according to claim 1 wherein the content of glycerol mixed with glycerides is 10-60%.

7. The agricultural and/or forestry method according to claim 1 wherein said mixture is used as a phytostimulating agent to promote the germination of seeds and/or as a fungicide/pesticide to protect seeds and/or crops from pathogenic microorganisms.

8. A phytostimulating composition for promoting seed germination and/or increasing the length of rootlets said composition comprising a mixture as defined claim 1.

9. A method for increasing the germination of seeds and/or the length of the rootlets, said method comprising treating the seed by imbibition with the phytostimulating composition according to claim 8 as such and/or an aqueous solution thereof.

10. A fungicide/pesticide composition comprising a mixture as defined in claim 1 and optionally a copper based fungicide.

11. A fungicide/pesticide method comprising treating a crop with a fungicide/pesticide composition according to claim 10.

12. A seed tanning composition, said composition comprising a mixture as defined in claim 1.

13. A method of tanning a seed, said method comprising contacting the seed with the tanning composition according to claim 12.
